(19) United States
(12) Patent Application Publication
(10) Pub. No.: US 2013/0032028 A1
(43) Pub. Date: Feb. 7, 2013

(54) METHOD FOR OPERATING GAS SEPARATION DEVICE

(71) Applicants: Yuzuru Miyazawa, Tsukuba-shi (JP); Yoko Aomura, Kawasaki-shi (JP); Yoshihiko Kobayashi, Kawasaki-shi (JP); Kenji Haraya, Tsukuba-shi (JP); Miki Yoshimune, Tsukuba-shi (JP)

(72) Inventors: Yuzuru Miyazawa, Tsukuba-shi (JP); Yoko Aomura, Kawasaki-shi (JP); Yoshihiko Kobayashi, Kawasaki-shi (JP); Kenji Haraya, Tsukuba-shi (JP); Miki Yoshimune, Tsukuba-shi (JP)

(73) Assignees: National Institute of Advanced Industrial Science, Chiyoda-ku, TOKYO (JP); Taiyo Nippon Sanso Corporation, Shinagawa-ku, TOKYO (JP)

(21) Appl. No.: 13/641,605

(22) PCT Filed: Apr. 8, 2011
(86) PCT No.: PCT/JP2011/058891

§ 371 Date: Oct. 16, 2012

(30) Foreign Application Priority Data
Apr. 26, 2010 (JP) 2010-101385
Apr. 26, 2010 (JP) 2010-101386

(51) Int. Cl. B01D 53/22; B01D 71/02

(52) U.S. Cl. 95/22; 95/26; 95/45; 95/55; 95/53

(57) ABSTRACT

Provided are a method for operating a gas separation device capable of performing gas separation with high separation capability and treatment amount in a small membrane area or in a small number of separation membrane modules, and a method for recovering a residual gas capable of performing more suitable detoxifying treatment or recycling by efficiently separating and recovering a mixed gas remaining in a cylinder, using the operating method. Two or more separation membrane modules are connected with each other in parallel. One separation membrane module is continuously and repeatedly operated in an operation cycle including: a first process for supplying a mixed gas into an airtight container and filling the airtight container with pressure; a second process for, when a predetermined time has elapsed or a predetermined pressure has been reached, stopping the supply of the mixed gas and retaining the supplied mixed gas; a third process for, when a predetermined time has elapsed or a predetermined pressure has been reached, recovering the mixed gas from a non-permeated gas discharge port; and a fourth process for, when a predetermined time has elapsed or a predetermined pressure has been reached, closing the non-permeated gas discharge port. The other separation membrane modules are operated in operation cycles shifted by respective predetermined intervals.

### TECHNICAL FIELD

The present invention relates to a method for operating a gas separation device, and a method for recovering a residual gas using the same.

Priority is claimed on Japanese Patent Application Nos. 2010-101385 and 2010-101386, filed Apr. 26, 2010, the content of which is incorporated herein by reference.

### BACKGROUND ART

Currently, various gases including hydride gases, such as monosilane, monogermane, arsine, phosphine, and hydrogen selenide, are representatively present in specialty gases used for the semiconductor field. Among these gases, monosilane, monogermane, arsine, phosphine, hydrogen selenide, and the like are gases that have strong toxicity and combustibility and that are very difficult to handle.

Particularly, although hydride gases are used as high-purity gases by themselves, hydride gases are also widely used as mixed gases diluted with gases, such as hydrogen or helium.

Here, it is known that, for example, a mixed gas diluted with hydrogen or the like can be safely utilized by separating the mixed gas into hydrogen and specialty gas immediately near a facility that uses the mixed gas, and sending the specialty gas alone to a gas-using facility.

Generally, it is known that, although the specialty gas is filled into a gas cylinder (bombe), a diluted mixed gas has a larger filling capacity for the specialty gas itself than a pure gas that is not diluted depending on the kind of specialty gases.

In a case where the used cylinder filled with the diluted mixed gas is returned, it is general to return the cylinder, with some gas being left within the cylinder as a residual gas. By separating and recovering this residual gas into a diluting gas and a specialty gas, an expensive specialty gas can be reused, and costs for treatment of the residual gas can also be reduced.

On the other hand, in a case where separation and recovery is not performed, all the residual gas remaining in the cylinder that is returned is subjected to suitable detoxifying treatment and then is discharged to the atmosphere.

As the treatment of the residual gas, for example, gases, such as xenon and krypton, which are not produced domestically, are diluted and discharged to the atmosphere. Gases having toxicity and combustibility, which are represented by monosilane, monogermane, arsine, phosphine, and hydrogen selenide, are also subjected to suitable detoxifying treatment, are diluted and discharged to the atmosphere.

Here, rare specialty gases are recycled as a result of growing interest in current environmental problems, and it is required as a social responsibility of enterprises that specialty gases having strong toxicity and combustibility are safely subjected to a detoxifying treatment.

For example, in the case of these pseudo-pure gases, such as xenon and krypton that are rare gases that are not produced in Japan, the residual gas thereof can be comparatively easily recovered. In the case of gases that are diluted and mixed with helium or the like, the current situation is that recovery is not performed if the time and effort required for performing separation treatment into dilution gas and specialty gas is considered.

Hydride gases, such as monosilane and monogermane, also have the same problems. Additionally, even in a case where detoxifying treatment is safely and appropriately performed without performing separation and recovery, particularly, in the case of gases that are diluted and mixed with hydrogen, if these gases are subjected to detoxifying treatment by a combustion detoxifying apparatus, a dry detoxifying apparatus, or the like, there are also problems that combustion heat or reaction heat is much generated under the influence of hydrogen, a burden is imposed on the detoxifying apparatus, safety is unstable, and substantial costs are also incurred.

The treatment that does not separate and recover the residual gas remaining in the cylinder that is returned, includes facilities (refer to Patent Document 11) that are automated in order to reduce manpower required for the work of residual gas discharge and vacuuming, facilities (refer to Patent Documents 12 and 13) that discharge and treat the residual gas of a gas that is liquefied at ordinary temperature, or the like.

Additionally, methods for recovering and treating the gas used in a gas-using facility include a facility and a method for storing this gas once used in a gas bag or the like and conveying the gas bag to a place with a recovery treatment facility, and performing recovery treatment there (refer to Patent Document 14), a facility and a method in which a gas recovery treatment facility is installed immediately near a gas-using facility and used gas is recovered and treated there (refer to Patent Documents 14 to 17), and the like.

Moreover, methods for separating a mixed gas using separation membranes include a method for separating the mixed gas into hydride gas, and hydrogen, helium, or the like, using polyimide membranes, polyaramid membranes, polysulfone membranes, or the like (refer to Patent Documents 18 to 20).

Currently, a membrane separation technique is attracting much attention particularly in the field of water treatment as an excellent separation technique with an energy saving effect.

This membrane separation technique is similar to a compressor in which basic power is used to perform boosting, and the energy saving property thereof in separation of gases can be expected as compared with PSA or rectification. Moreover, in the membrane separation technique, separation operation can be performed by vacuuming the permeation side of the membranes. Therefore, this technique has an advantage that it is possible to cope with even low vapor-pressure gases for which it is difficult to obtain sufficient supply pressure, and even spontaneously combustible gases or self-decomposable gases can be safely separated and operated; an advantage that it is possible to cope with even gases that are easily decomposed by the catalytic action of metal or gases that reacts easily with metal; an advantage that there are few driving machines, there are no problems, and maintenance is unnecessary; and an advantage that the separation of high-concentration impurities does not need an additional operation, such as recycling, or the like.

As methods for operating separation membranes (including some water treatment operating methods), operating methods for controlling the flow rate, concentration, or recovery rate of a target gas by measuring and adjusting the pressure or flow rate on the high-pressure side of membranes or the pressure or flow rate on the low-pressure side of the membranes have been disclosed (refer to Patent Documents 1 to 3).

Additionally, operating methods for controlling the flow rate, concentration, or recovery rate of a target gas by connecting a plurality of stages of separation membrane in series and adding the above-described control are disclosed (refer to Patent Documents 4 to 7).

Moreover, operating methods for controlling the flow rate, concentration, or recovery rate of a target gas by connecting a plurality of stages of separation membrane in series and controlling the supply flow rate or supply pressure to separation membranes, and the number of the membranes are disclosed (refer to Patent Documents 8 and 9).

Moreover, an operating method for performing long-term and stable operation by connecting a plurality of stages of separation membrane in parallel, cleaning and regenerating the other separation membranes while one separation membrane is used, and repeating and switching has been disclosed (refer to Patent Document 10).

### CITATION LIST

### Patent Document

[Patent Document 1] Japanese Patent No. 3951569
[Patent Document 2] Japanese Unexamined Patent Application, First Publication No. 2008-104949
[Patent Document 3] Japanese Unexamined Patent Application, First Publication No. 2009-61418
[Patent Document 4] Japanese Unexamined Patent Application, First Publication No. 2008-238099
[Patent Document 5] Japanese Patent No. 4005733
[Patent Document 6] Japanese Unexamined Patent Application, First Publication No. 2002-166121
[Patent Document 7] Japanese Unexamined Patent Application, First Publication No. 6-205924
[Patent Document 8] Japanese Unexamined Patent Application, First Publication No. 2002-37612
[Patent Document 9] Japanese Patent No. 3598912
[Patent Document 10] Japanese Unexamined Patent Application, First Publication No. 2002-28456
[Patent Document 11] Japanese Patent No. 3188502
[Patent Document 12] Japanese Unexamined Patent Application, First Publication No. 6-201097
[Patent Document 13] Japanese Unexamined Patent Application, First Publication No. 2007-24300
[Patent Document 14] Japanese Patent No. 3925365
[Patent Document 15] Japanese Unexamined Patent Application, First Publication No. 2001-353420
[Patent Document 16] Japanese Patent No. 4112659
[Patent Document 17] Japanese Unexamined Patent Application, First Publication No. 2000-325732
[Patent Document 18] Japanese Unexamined Patent Application, First Publication No. 7-171330
[Patent Document 19] Japanese Unexamined Patent Application, First Publication No. 2002-308608
[Patent Document 20] U.S. Pat. No. 2,615,265

### SUMMARY OF INVENTION

### Technical Problem

However, in the above-described related art, particularly, a method for recovering the residual gas of the mixed gas remaining in the gas cylinder is not disclosed at all.

Additionally, the disclosed related art has problems in that, in order to make the concentration of the target gas higher, it is necessary to connect the plurality of stages of separation membrane modules in series and a number of separation membranes are required. Additionally, there is a problem in that, in order to improve the treatment amount of gas, more separation membranes are required.

An object of the invention is to provide a method for recovering a residual gas, capable of performing more suitable detoxifying treatment or recycling by efficiently separating and recovering the mixed gas that remains in the cylinder. Particularly, another object of the invention is to safely and simply perform separation and recovery of a mixed gas in which hydride gas is diluted and mixed with hydrogen, helium, or the like.

Moreover, the invention has been made in view of the above problems, and still another object of the invention is to provide a method for operating a gas separation device capable of performing gas separation with high separation capability and treatment amount, even in a small membrane area or even in a small number of separation membrane modules.

### Solution to Problem

In order to solve the above problems, a first invention is a method for operating a gas separation device that separates a gas component with a small molecular diameter from a mixed gas containing another gas component with a large molecular diameter, using two or more separation membrane modules including gas separation membranes. The two or more separation membrane modules are connected in parallel. One separation membrane module continuously repeats an operation cycle including a first process in which a gas supply port is opened to supply a mixed gas containing the gas component with a small molecular diameter and the gas component with a large molecular diameter into an airtight container, and fill the airtight container with pressure, in a state where a non-permeated gas discharge port provided so as to communicate with a space on a non-permeation side of the gas separation membranes, of the airtight container in which the gas separation membranes are housed, is closed, and a permeated gas discharge port provided so as to communicate with a space on a permeation side of the gas separation membranes is open; a second process in which the gas supply port is closed to stop supply of the mixed gas and retain this state, when a predetermined time has elapsed from a start of supply of the mixed gas or when an inside of the airtight container has reached a predetermined pressure; a third process in which the non-permeated gas discharge port is opened to recover the mixed gas containing the gas component with a large molecular diameter from the non-permeated gas discharge port, when a predetermined time has elapsed from a start of the remaining state or when the inside of the airtight container has reached a predetermined pressure; and a fourth process in which the non-permeated gas discharge port is closed when a predetermined time has elapsed from a start of the recovery or when the inside of the airtight container has reached a predetermined pressure. The other separation membrane module is operated in an operation cycle shifted by a predetermined interval with respect to the operation cycle of this one separation membrane module.

A second invention is the method for operating a gas separation device in the first invention, in which the gas separation membrane is any one of a silica membrane, a zeolite membrane, and a carbon membrane.

A third invention is the method for operating a gas separation device in the first or second invention, in which in the third process, when a drop in pressure on the non-permeation side within the airtight container has stopped, it is determined that a separation of the gas component with a small molecular diameter has been completed.

A fourth invention is the method for operating a gas separation device in any one of the first to third inventions, in which a separation membrane module is connected in series with a preceding stage of the two or more separation membrane modules which are connected in parallel, and the mixed gas is continuously supplied to the separation membrane module provided at the preceding stage, thereby performing rough separation treatment of the gas component with a small molecular diameter from the mixed gas.

A fifth invention is the method for operating a gas separation device in any one of the first to third inventions, in which the number of separation membrane modules which are connected in parallel is more than or equal to a value obtained by dividing the time required for the operation cycle by the time required for the first process, and is expressed by an integer.

A sixth invention is a method for recovering a residual gas. The method includes continuously supplying a mixed gas remaining in a cylinder to a separation membrane module including a gas separation membrane having a molecular sieving action; separating the mixed gas into a gas component with a small molecular diameter and a gas component with a large molecular diameter; and then, recovering both the gas component with a small molecular diameter and the gas component with a large molecular diameter.

A seventh invention is a method for recovering a residual gas. The method includes supplying a mixed gas remaining in a cylinder to a separation membrane module including a gas separation membrane having a molecular sieving action; separating the mixed gas into a gas component with a small molecular diameter and a gas component with a large molecular diameter; and then, recovering both the gas component with a small molecular diameter and the gas component with a large molecular diameter. The separation membrane module continuously repeats an operation cycle including a first process in which a gas supply port is opened to supply a mixed gas containing the gas component with a small molecular diameter and the gas component with a large molecular diameter into an airtight container, and fill the airtight container with pressure, in a state where a non-permeated gas discharge port provided so as to communicate with a space on a non-permeation side of the gas separation membranes, of the airtight container in which the gas separation membranes are housed, is closed, and a permeated gas discharge port provided so as to communicate with a space on a permeation side of the gas separation membranes is open; a second process in which the gas supply port is closed to stop supply of the mixed gas and retain this state, when a predetermined time has elapsed from a start of supply of the mixed gas or when an inside of the airtight container has reached a predetermined pressure; a third process in which the non-permeated gas discharge port is opened to recover the mixed gas containing the gas component with a large molecular diameter from the non-permeated gas discharge port, when a predetermined time has elapsed from a start of the retaining state or when the inside of the airtight container has reached a predetermined pressure; and a fourth process in which the non-permeated gas discharge port is closed when a predetermined time has elapsed from a start of the recovery or when the inside of the airtight container has reached a predetermined pressure.

An eighth invention is a method for recovering a residual gas. The method includes supplying a mixed gas remaining in a cylinder to a separation membrane module including gas separation membranes having a molecular sieving action; separating the mixed gas into a gas component with a small molecular diameter and a gas component with a large molecular diameter; and then, recovering both the gas component with a small molecular diameter and the gas component with a large molecular diameter. The two or more separation membrane modules are connected in parallel. One separation membrane module continuously repeats an operation cycle including a first process in which a gas supply port is opened to supply a mixed gas containing the gas component with a small molecular diameter and the gas component with a large molecular diameter into an airtight container, and fill the airtight container with pressure, in a state where a non-permeated gas discharge port provided so as to communicate with a space on a non-permeation side of the gas separation membranes, of the airtight container in which the gas separation membranes are housed, is closed, and a permeated gas discharge port provided so as to communicate with a space on a permeation side of the gas separation membranes is open; a second process in which the gas supply port is closed to stop supply of the mixed gas and retain this state, when a predetermined time has elapsed from a start of supply of the mixed gas or when an inside of the airtight container has reached a predetermined pressure; a third process in which the non-permeated gas discharge port is opened to recover the mixed gas containing the gas component with a large molecular diameter from the non-permeated gas discharge port, when a predetermined time has elapsed from a start of the retaining state or when the inside of the airtight container has reached a predetermined pressure; and a fourth process in which the non-permeated gas discharge port is closed when a predetermined time has elapsed from a start of the recovery or when the inside of the airtight container has reached a predetermined pressure. The other separation membrane module is operated in an operation cycle shifted by a predetermined interval with respect to the operation cycle of this one separation membrane module.

A ninth invention is the method for recovering a residual gas in any one of the inventions 6 to 8, in which the gas separation membrane is any one of a silica membrane, a zeolite membrane, and a carbon membrane.

A tenth invention is the method for recovering a residual gas in any one of the sixth to ninth inventions, in which the gas component with a small molecular diameter is any one of hydrogen and helium or a mixture of two or more components thereof.

An eleventh invention is the method for recovering a residual gas in any one of the sixth to tenth inventions, in which the gas component with a large molecular diameter is any one among hydride gases including arsine, phosphine, hydrogen selenide, monosilane and monogermane, and rare gases including xenon and krypton, or a mixture of two or more components thereof.

### Advantageous Effects of Invention

According to the method for operating a gas separation device in the invention, when the gas component with a large molecular diameter and the gas component with a small molecular diameter are separated, gas separation can be performed with high gas separation performance and treatment capability in a small number of separation membrane modules. Additionally, since a required number of gas separation membranes are connected in parallel, and are operated while being shifted by a predetermined interval, it is possible to perform continuous separation operation as an overall system.

According to the method for recovering a residual gas in the invention, the mixed gas remaining in the returned cylinder can be efficiently separated and recovered. This makes it possible to simply perform detoxifying treatment or recycling.

### BRIEF DESCRIPTION OF DRAWINGS

FIG. 1 is a system diagram showing an example of a gas separation device used for a method of operating a gas separation device in the invention.

FIG. 2A is a view showing an example (two modules in parallel and batch operation) of a timing chart of batch operation in the method of operating a gas separation device in the invention.

FIG. 2B is a view showing an example (two modules in parallel and batch operation) of a timing chart of batch operation in the method of operating a gas separation device in the invention.

FIG. 3 is a system diagram showing another example of the gas separation device used for the method of operating a gas separation device in the invention.

FIG. 4A is a view showing an example (two modules in series and continuous operation) of a timing chart of continuous operation in the method of operating a gas separation device in the invention.

FIG. 4B is a view showing an example (two modules in series and continuous operation) of a timing chart of continuous operation in the method of operating a gas separation device in the invention.

FIG. 5A is a view showing an example (two modules in parallel and continuous operation) of a timing chart of continuous operation in the method of operating a gas separation device in the invention.

FIG. 5B is a view showing an example (two modules in parallel and continuous operation) of a timing chart of continuous operation in the method of operating a gas separation device in the invention.

FIG. 6 is a system diagram showing an example of a recovery device used for a method of recovering a residual gas that is a second embodiment of the invention.

FIG. 7 is an enlarged cross-sectional view of a separation membrane module used for the recovery device of the second embodiment of the invention.

FIG. 8 is a system diagram showing an example of a recovery device used for a method of recovering a residual gas that is a third embodiment of the invention.

FIG. 9 is an enlarged cross-sectional view of a separation membrane module used for the recovery device of the third embodiment of the invention.

FIG. 10 is a system diagram showing an example of a recovery device used for a method of recovering a residual gas that is a fourth embodiment of the invention.

FIG. 11 is a view showing the relationship between residual gas pressure (back pressure), respective flow rate behaviors, and monosilane (SiH₄) concentrations in respective gases, in Example B1 of the invention.

FIG. 12 is a view showing an example of a timing chart in batch operation when the residual gas pressure (=filling pressure) is 0.2 MPaG, in Example B2 of the invention.

FIG. 13 is a view showing an example of a timing chart in batch operation when the residual gas pressure (filling pressure) is 0.05 MPaG, in Example B2 of the invention.

### DESCRIPTION OF EMBODIMENTS

### First Embodiment

An example of a form for carrying out the invention will be described below in detail, referring to the drawings.

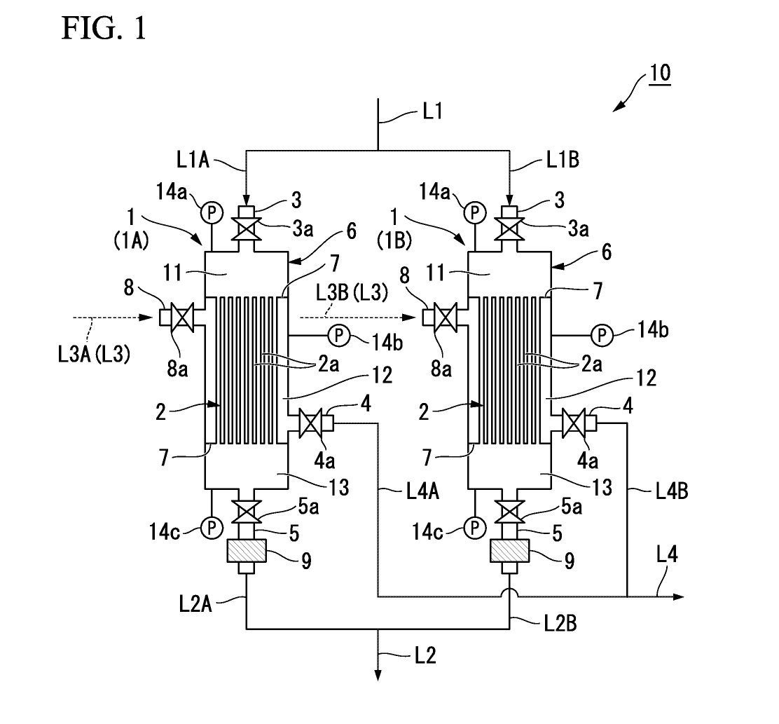

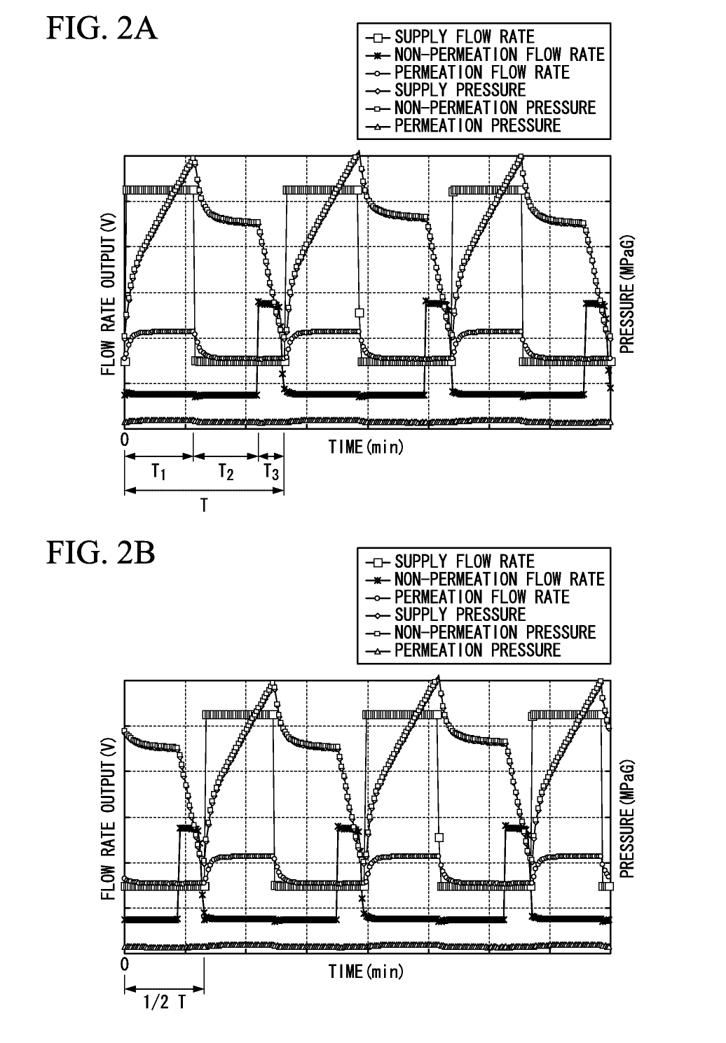

An example of a gas separation device used for a method for operating a gas separation device in the invention is shown in FIGS. 1 and 2. In addition, in the example of the gas separation device, a carbon membrane module is used as an example of a separation membrane module. Additionally, in this carbon membrane module, a carbon membrane is used as a gas separation membrane.

In FIG. 1, reference numeral 10 designates a gas separation device and reference numeral 1 (1A, 1B) designates a carbon membrane module. The gas separation device 10 is schematically configured such that two carbon membrane modules 1A and 1B are connected in parallel by paths L1 to L4.

Additionally, the carbon membrane module 1 (1A, 1B) is generally constituted by an airtight container 6 and a carbon membrane unit 2 provided within the airtight container 6.

The airtight container 6 is a hollow cylinder and the carbon membrane unit 2 is housed in the internal space of the container. Additionally, a gas supply port 3 is provided at one longitudinal end portion of the airtight container 6, and a non-permeated gas discharge port 5 is provided at the other end. Moreover, the peripheral surface of the airtight container 6 is provided with a permeated gas discharge port 4 and a sweeping gas supply port 8.

The carbon membrane unit 2 is constituted by multiple hollow fiber-like carbon membranes 2a . . . that are gas separation membranes, and a pair of resin walls 7 that bundles and fixes both ends, respectively, of the hollow fiber-like carbon membranes 2a . . . . The resin walls 7 are anchored to the inner wall of the airtight container 6 using an adhesive or the like. Additionally, the pair of resin walls 7 is respectively formed with opening portions of the hollow fiber-like carbon membranes 2a . . . .

The inside of the airtight container 6 is split into three spaces of a first space 11, a second space 12, and a third space 13 by the pair of resin walls 7. The first space 11 is the space between one end portion of the airtight container 6 provided with the gas supply port 3, and the resin walls 7, the second space 12 is the space between the peripheral surface of the airtight container 6 and the pair of resin walls 7, and the third space 13 is the space between the other end portion provided with the non-permeated gas discharge port 5, and the resin walls 7.

Additionally, a pressure gauge 14a is provided in the first space 11, a pressure gauge 14b is provided in the second space 12, and a pressure gauge 14c is provided in the third space 13 so that the internal pressure can be measured.

The gas supply port 3 is provided so as to communicate with the first space 11 within the airtight container 6. Additionally, the gas supply port 3 is provided with an opening and closing valve 3a. Thus, a mixed gas can be supplied from the mixed gas supply path L1 (L1A, L1B) via the gas supply port 3 into the first space 11 by opening the opening and closing valve 3a.

The non-permeated gas discharge port 5 is provided so as to communicate with the third space 13 within the airtight container 6. Additionally, the non-permeated gas discharge port 5 is provided with an opening and closing valve 5a. Thus, a non-permeated gas can be discharged from the third space 13 via the non-permeated gas discharge port 5 to a non-permeated gas discharge path L2 (L2A, L2B) by opening the opening and closing valve 5a.

The permeated gas discharge port 4 and the sweeping gas supply port 8 are provided so as to communicate with the second space 12 within the airtight container 6. Additionally, the permeated gas discharge port 4 is formed with an opening and closing valve 4a, and the sweeping gas supply port 8 is provided with an opening and closing valve 8a. Thus, a permeated gas can be discharged from the second space 12 via the permeated gas discharge port 4 to the permeated gas discharge path L4 (L4A, L4B) by opening the opening and closing valve 4a. On the other hand, a sweeping gas can be supplied from the sweeping gas supply path L3 (L3A, L3B) via the sweeping gas supply port 8 to the second space 12 by opening the opening and closing valve 8a.

One end of each of the hollow fiber-like carbon membranes 2a . . . is fixed to one resin wall 7 and opens, and the other end thereof is fixed to the other resin wall 7 and opens. Thereby, in a portion where the hollow fiber-like carbon membranes 2a . . . are fixed in one resin wall 7, one opening portion of each of the hollow fiber-like carbon membranes 2a . . . leads to the first space 11 and the other opening portion thereof leads to the third space 13. Thereby, the first space 11 and the third space 13 are allowed to communicate with each other via the internal spaces of the hollow fiber-like carbon membranes 2a . . . . On the other hand, the first space 11 and the second space 12 are allowed to communicate with each other via the carbon membrane unit 2.

The hollow fiber-like carbon membranes 2a . . . are prepared by being sintered after an organic polymer membrane is formed. For example, polyimide that is an organic polymer is dissolved in an arbitrary solvent to prepare a membrane-forming stock solution, and a solvent that mixes with the solvent of the membrane-forming stock solution, but does not dissolve polyimide is prepared. Subsequently, an organic polymer membrane is manufactured by extruding the membrane-forming stock solution into a solidified liquid from a peripheral edge portion annular port of a hollow fiber spinning nozzle having a duplex tube structure, and simultaneously extruding the solvent into the solidified liquid from a central portion circular port of the spinning nozzle, thereby molding hollow fibers. Next, the obtained organic polymer membrane is carbonized as a carbon membrane after being subjected to infusibilization treatment.

The carbon membrane that is an example of the gas separation membrane of the invention is used by selecting optimal forms, such as one coated on a porous support and one coated on the gas separation membrane other than the carbon membrane, besides being used only as the carbon membrane. The porous support includes filters made of alumina, silica, zirconia, magnesia, and zeolite that are ceramic-based, metal-based filters, or the like. Coating on the support has effects such as improvement in mechanical strength, and simplification of carbon membrane manufacture.

Particularly, a gas separation membrane that usually performs separation operation in a steady state is used in the invention after being subjected to pressure swing like PSA to be described below. Therefore, it is required that the gas separation membrane have excellent stability against the pressure swing, that is, have machine strength that is superior to the related art. Accordingly, in the present invention, it is preferable to use gas separation membranes that are inorganic membranes, such as a silica membrane, a zeolite membrane, and a carbon membrane, rather than the gas separation membrane that is a general polymer membrane.

In addition, organic polymers used as the raw materials of the carbon membrane include polyimide (aromatic polyimide), polyphenylene oxide (PPO), polyamide (aromatic polyamide), polypropylene, polyfurfuryl alcohol, polyvinylidene chloride (PVDC), phenol resin, cellulose, lignin, polyether imide, cellulose acetate, or the like.

With polyimide (aromatic polyimide), cellulose acetate, and polyphenylene oxide (PPO) among the raw materials of the above carbon membrane, molding of the hollow fiber-like carbon membrane is easy. Particularly, polyimide (aromatic polyimide) and polyphenylene oxide (PPO) have high separation performance. Moreover, polyphenylene oxide (PPO) is inexpensive compared to polyimide (aromatic polyimide).

Next, a method for operating the gas separation device 10 shown in FIG. 1 will be described.

The method for operating the gas separation device 10 in the invention is a method for connecting separation membrane modules equipped with two or more gas separation membranes in parallel, and separating a gas component with a small molecular diameter from a mixed gas containing the other gas components with a large molecular diameter. In this example, a case where separation membrane modules are adopted as the carbon membrane modules using carbon membranes having a molecular sieving action, and a mixed gas of a dilution gas and a hydride gas is adopted as the mixed gas that serves as a target to be separated will be described. Here, the molecular sieving action is an action by which a gas with a small molecular diameter and a gas with a large molecular diameter are separated depending on the size of the molecular diameters of gases and the diameter of pores of the separation membranes.

The mixed gas that is a target to be separated and concentrated is a mixture of two or more kinds of components including a gas component with a small molecular diameter and a gas component with a large molecular diameter. As long as there is a difference in molecular diameter between these gas components, combinations of any kinds of gas components may be adopted. If the difference in molecular diameter between these components is larger, the treatment time required for separation operation can be further shortened.

The dilution gas in the mixed gas is a gas component with a small molecular diameter in many cases, for example, it is preferable to use gas components in which the molecular diameter is more than or equal to 3 Å like hydrogen or helium. In contrast, the hydride gas in the mixed gas is a gas component with a large molecular diameter in many cases, for example, a gas component in which the molecular diameter is more than 3 Å, preferably more than or equal to 4 Å, and more preferably more than or equal to 5 Å.

The mixed gas is not limited to a two-component system, and may be a mixture of a plurality of gas components. However, in order to sufficiently separate respective gas components to either a permeation side or a non-permeation side of the separation membranes, it is preferable to roughly sort the gas components into a gas component group with a large molecular diameter and a gas component group with a small molecular diameter. The diameter of pores of the carbon membranes may be between the molecular diameter of the gas component group with a large molecular diameter and the molecular diameter of the gas component group with a small molecular diameter. In addition, the diameter of the pores of the carbon membranes can be adjusted by changing the combustion temperature during carbonization.

In the method for operating the gas separation device 10 in the invention, first, any one of the carbon membrane modules connected in parallel, for example, a carbon membrane module 1A is continuously and repeatedly operated in an operation cycle including the following first to fourth processes.

(First Process)

First, in a supply process that is a first process, the opening and closing valve 3a of the gas supply port 3 is opened to supply the mixed gas into the airtight container 6 from the mixed gas supply path L1A and fill the container with pressure, in a state where the opening and closing valve 5a of the non-permeated gas discharge port 5, which is provided so as to communicate with the third space 13 (space on the non-permeation side of the gas separation membranes) of the airtight container 6 in which the carbon membrane unit 2 is housed, is closed, and the opening and closing valve 4a of the permeated gas discharge port 4 provided so as to communicate with the second space 12 (space on the permeation side of the gas separation membranes) is open.

As shown in FIG. 2A, in the first process, the mixed gas is supplied at a constant flow rate into the airtight container 6 from the gas supply port 3. Here, since the non-permeated gas discharge port 5 that is on the non-permeation side of the airtight container 6 is closed, the pressure (supply pressure) of the first space 11 rises if the mixed gas is supplied at a constant flow rate. Accordingly, the pressure within the third space 13 that is on the non-permeation side of the carbon membrane unit 2 within the airtight container 6 (non-permeation pressure) also rises.

In contrast, since the permeated gas discharge port 4 that is on the permeation side of the airtight container 6 is open, the pressure (permeation pressure) of the second space 12 does not change. Additionally, since the dilution gas in the mixed gas permeates the carbon membrane unit 2, moves to the second space 12, and is discharged from the permeated gas discharge port 4 to the permeated gas discharge path L4A, the permeation flow rate becomes constant after being temporarily increased.

In addition, the supply pressure is measured by the pressure gauge 14a, the non-permeation pressure is measured by the pressure gauge 14c, and the permeation pressure is measured by the pressure gauge 14b.

In addition, the required time (T₁) of the first process is not particularly limited and can be appropriately selected according to individual conditions, such as the volume (V) of the airtight container 6, the performance (P, S) of the carbon membrane unit 2, and the supply flow rate (F) and filling pressure (A) of the mixed gas.

If the volume (V) of the airtight container 6 becomes large, the amount of the mixed gas to be supplied to the airtight container 6 increases, and if the supply flow rate of the mixed gas does not change, the time required for the first process becomes long. Additionally, since the amount of the mixed gas to be supplied increases, the recovery amount after separation increases.

If the filling pressure (A) is made high, the amount of the mixed gas to be supplied to the airtight container 6 increases, and if the supply flow rate of the mixed gas does not change, the time required for the first process becomes long. Additionally, since the amount of the mixed gas to be supplied increases, the recovery amount after separation increases. However, since there is a possibility that damage, such as breakage, may be caused to the carbon membrane unit 2 when the filling pressure is too high, it is preferable that the filling pressure is lower than or equal to 1 MPaG. Moreover, in the case of the hydride gas that is a separation target of the invention, it is preferable from a viewpoint of safety that the pressure be not raised too much. Therefore, the pressure is preferably set to 0.5 MPaG or lower, and the pressure is more preferably set to 0.2 MPaG or lower.

In a case where the permeation side has the atmospheric pressure, the lower limit of the filling pressure is preferably set to 0.05 MPaG or higher and more preferably set to 0.1 MPaG or higher.

If the permeation side is vacuumed, the filling pressure is preferably within a range of 0 to 0.05 MPaG.

The performance (the permeation speed of the permeated component) (P) of the carbon membrane unit 2 represents the permeation speed of a component that permeates the carbon membranes 2a. For example, in a case where the permeated component is hydrogen, the required time becomes long if the permeation speed of hydrogen is high. This is because hydrogen escapes simultaneously with pressure filling, and therefore pressure filling is performed with monosilane that is a non-permeated component.

The performance (separation performance) (S) of the carbon membrane unit 2 represents the performance of separating the mixing gas into a component that permeates the carbon membranes 2a, and a component (residual component) that does not permeate. For example, in a case where the permeated component is hydrogen and the residual component is monosilane, the required time becomes short if the separation performance for hydrogen and monosilane is excellent. This is because monosilane remains without permeating the carbon membranes 2a, that is, the permeation speed of monosilane becomes low, and therefore, the pressure filling is performed early.

If the supply flow rate (F) of the mixed gas is large, the required time becomes short. However, since there is a possibility that damage, such as breakage, is caused to the carbon membrane unit 2, it is preferable to supply the mixed gas at a linear speed of 10 cm/sec or lower, and it is more preferable to supply the mixed gas at a linear speed of 1 cm/sec or lower. However, the linear speed is not limited to this in a case where a resistance plate, a diffusion plate, or the like is introduced so that a gas flow does not directly contact the carbon membranes 2a.

The required time (T₁) for the first process is correlated with the individual conditions described above as in the following Expression (1).

T₁∝(V×A×P)/(S×F) (1)

For example, in the case of airtight containers shown in examples to be described below, in which carbon membrane units with a membrane area of 1114 cm² (membrane performance:permeation speed of hydrogen=5×10⁻⁵ cm³(STP)/cm²/sec/cmHg, and (separation factor of hydrogen/monosilane)=about 5000) are sufficiently densely provided, the filling pressure reaches 0.2 MPaG in about 7 minutes in a case where a mixed gas of 10% of monosilane and 90% of hydrogen is supplied at a flow rate of 150 sccm.

(Second Process)

Next, in the separation process that is a second process, the opening and closing valve 3a of the gas supply port 3 is closed to stop supply of the mixed gas and retain this state, when a predetermined time T₁ has elapsed from the start of supply of the mixed gas or when the pressure within the airtight container 6 (supply pressure or non-permeation pressure) has reached a predetermined pressure (filling pressure A).

It is thereby possible to cause only the dilution gas that is a gas component with a small molecular diameter to permeate into the low-pressure side (the second space 12) of the carbon membranes selectively and preferentially from the mixed gas supplied to the non-permeation side (the first and third spaces 11 and 13) of the carbon membrane unit 2, and it is possible to cause the hydride gas that is a gas component with a large molecular diameter to remain on the non-permeation side.

As shown in FIG. 2A, since the supply of the mixed gas into the airtight container 6 from the gas supply port 3 is stopped in the second process, the supply flow rate becomes 0. At this time, although the opening and closing valves 3a and 5a of the gas supply port 3 and the non-permeated gas discharge port 5 that are on the non-permeation side of the airtight container 6 are closed, since the permeated gas discharge port 4 is open and the dilution gas within the mixed gas permeates the carbon membrane unit 2 and is discharged from the permeated gas discharge port 4 to the permeated gas discharge path L4A, the supply pressure and the non-permeation pressure drop gradually.

On the other hand, since the permeated gas discharge port 4 that is on the permeation side of the airtight container 6 is open, there are no changes in the pressure (permeation pressure) of the second space 12. However, the permeation flow rate of the dilution gas discharged from the permeated gas discharge port 4 to the permeated gas discharge path L4A decreases gradually.

In addition, the required time (T₂) for the second process is not particularly limited and can be appropriately selected according to the volume (V) of the airtight container 6, the filling pressure (A), the separation termination predetermined pressure (referred to as discharge pressure, B), the performance (P, S) of the carbon membrane unit 2, and the composition (Z) of a supply gas.

Here, the volume (V) of the airtight container 6, the filling pressure (A), and the performance (separation performance) (S) of the carbon membrane unit 2 are as described in the first process.

As for the performance (permeation speed of the permeated component) (P) of the carbon membrane unit 2, the required time becomes short if the permeation speed is high, for example, in a case where the permeated component is hydrogen. This is because hydrogen escapes early.

If the discharge pressure (B) is high, the time required for the second process becomes short. However, if the discharge pressure is high compared to an ideal discharge pressure, the mixed gas is not sufficiently separated, and a recovered gas is not concentrated with a high purity or in a high concentration.

The composition (Z) of the supply gas is an index representing gas composition, and is a permeated gas component amount/residual gas component amount.

The required time (T₂) of the second process is correlated with the individual conditions described above as in the following Expression (2).

T₂∝(V×A)/(B×P×S) (2)

Moreover, the discharge pressure (B) is correlated as in the following Expression (3).

Discharge pressure (B)=1/(F×Z) (3)

Here, if the supply flow rate (F) of the mixed gas is large, the discharge pressure (B) becomes small from Expression (3). This means that, since the filling pressure is reached earlier if the supply flow rate (F) of the mixed gas is large, the separation rate in the first process becomes small and most is separated in the second process.

On the other hand, if the supply flow rate (F) of the mixed gas is small, the discharge pressure (B) becomes large. This means that, since separation is sufficiently made in the first process and the filling pressure is nearly reached with a residual-gas component as the supply flow rate (F) of the mixed gas is small, the difference between the filling pressure (A) and the discharge pressure (B) becomes small.

Since the partial pressure of the permeated gas component is small in a case where the composition (Z) of the supply gas is large, the discharge pressure (B) becomes small.

For example, in a case where the airtight containers shown in the examples to be described below, in which carbon membrane units with a membrane area of 1114 cm² (membrane performance:permeation speed of hydrogen=5×10⁻⁵ cm³(STP)/cm²/sec/cmHg, and (separation factor of hydrogen/monosilane)=about 5000 are sufficiently densely provided are filled with a mixed gas of 10% of monosilane and 90% of hydrogen with a filling pressure of 0.2 MPaG, the discharge pressure 0.12 MPaG is reached in about 5 minutes.

(Third Process)

Next, in the discharge process that is a third process, the opening and closing valve 5a of the non-permeated gas discharge port 5 is opened to recover a mixed gas containing the hydride gas from the non-permeated gas discharge port 5, when a predetermined time (T₂) has elapsed from the start of the retaining state or when the inside (that is, the first space 11 and third space 13 that are non-permeation sides) of the airtight container 6 has reached a predetermined pressure.

Thereby, the mixed gas containing the hydride gas that is concentrated (formed with high purity) higher than the hydride gas concentration in the mixed gas supplied to the carbon membrane module 1 is obtained.

Here, the time when the inside (that is, the first space 11 and the third space 13 that are the non-permeation sides) of the airtight container 6 has reached a predetermined pressure shows that drops in the supply pressure and the non-permeation pressure that are the high-pressure side have stopped. That is, it is shown that all the dilution gas in the mixed gas supplied to the high-pressure side has permeated the carbon membranes 2a and only a mixed gas in which the hydride gas is concentrated is retained on the high-pressure side.

Accordingly, in the third process, when a drop in pressure on the non-permeation side within the airtight container 6 has stopped, it can be determined that the separation of the gas component with a small molecular diameter like the dilution gas has been completed.

As shown in FIG. 2A, in the third process, the flow rate of non-permeated gas rises simultaneously with the opening of the opening and closing valve 5a of the non-permeated gas discharge port 5. Simultaneously with that, the supply pressure and non-permeation pressure of the first and third spaces 11 and 13 that are the spaces on the non-permeation side drop gradually.

On the other hand, there is no change in the pressure (permeation pressure) of the second space 12, and the value of the permeation flow rate of the dilution gas from the permeated gas discharge port 4 is very small.

In addition, the required time (T₃) of the third process is not particularly limited, and can be appropriately selected according to the volume (V) of the airtight container 6, the discharge pressure (B), and the flow rate (referred to as discharge flow rate, G) of a discharge gas.

Here, the volume (V) of the airtight container 6 is as described in the first process.

If the discharge pressure (B) is high, the time required for the third process becomes long. This is because the amount of the residual gas component increases.

If the discharge flow rate (G) is large, the time required for the third process become short. However, there is a possibility that damage, such as breakage, may be caused to the carbon membrane unit 2. It is preferable to supply the mixed gas at a linear speed of 10 cm/sec or lower, and it is more preferable to supply the mixed gas at a linear speed of 1 cm/sec or lower. However, the linear speed is not limited to this in a case where a resistance plate, a diffusion plate, or the like is introduced so that a gas flow does not directly contact the carbon membranes 2a.

The required time (T₃) for the third process is correlated with the individual conditions described above as in the following Expression (4).

T₃∝(V×B)/(G) (4)

For example, in a case where discharge is made at about 100 sccm from a discharge pressure of 0.12 MPaG to the airtight containers shown in the examples to be described below, in which carbon membrane units with a membrane area of 1114 cm² (membrane performance:permeation speed of hydrogen=5×10⁻⁵ cm³(STP)/cm²/sec/cmHg, and (separation factor of hydrogen/monosilane)=about 5000 are sufficiently densely provided, 0 MPaG is reached in about 2 minutes.

(Fourth Process)

Next, the opening and closing valve 5a of the non-permeated gas discharge port 5 is closed when a predetermined time (T₃) has elapsed from the recovery of the mixed gas containing the hydride gas or when the inside (that is, the first space 11 and third space 13 that are non-permeation sides) of the airtight container 6 has reached a predetermined pressure. This brings return to a state immediately before the start of the first process.

Accordingly, the above predetermined pressure shows the pressure in an initial state (a state immediately before the start of the first process). The supply side preferably has 0 MPaG, and the non-permeation side preferably has 0 MPaG or is a vacuum.

In addition, if the required time (T) of the operation cycle in the method for operating the gas separation device in the invention is expressed by the required times of the above-described respective processes, the required time can be expressed as in the following Expression (5).

T=T₁+T₂+T₃ (5)

In the method for operating the gas separation device in the invention, first, any one carbon membrane module 1A connected in parallel is characterized by continuously repeating an operation cycle that includes the separation operation (hereinafter referred to as “batch operation”) of such first to fourth processes (such a system is referred to as “batch-wise”).

Through such batch operation, the hydride gas with a large molecular diameter is concentrated and separated on the high-pressure side (non-permeation side of the carbon membrane unit 2) of the carbon membrane module 1 (separation membrane) in the first and second processes, and is recovered in the third process. On the other hand, the dilution gas with a small molecular diameter, such as hydrogen or helium, is continuously recovered from the low-pressure side (permeation side of the carbon membrane unit 2) of the carbon membrane module 1 (separation membrane) in the first to fourth processes.

Next, the other carbon membrane module 1B connected in parallel is operated in the same operation cycle shifted by a predetermined interval with respect to the operation cycle of the carbon membrane module 1A.

Specifically, in a case where two carbon membrane modules are connected in parallel, as shown in FIG. 2B, it is preferable to shift the phase of the operation cycle of the carbon membrane module 1B with respect to that of the carbon membrane module 1A by a ½ cycle. This enables the whole gas separation device 10 to perform continuous separation operation.

Moreover, in a case where two carbon membrane modules are connected in parallel and are operated with their operation cycles being shifted by a ½ cycle, it is preferable to satisfy the relationship of T₁=½T, that is, T₁=T₂+T₃ in the above Expression (5).

Incidentally, in a gas separation method of the related art using gas separation membranes, for example, in a case where a mixed gas of 90% of hydrogen with a small molecular diameter and 10% of monosilane with a large molecular diameter was continuously supplied to carbon membranes as the gas separation membranes, the separation performance of hydrogen was about 100% on the permeation side, and the separation performance of monosilane was about 60% (40% of hydrogen) on the non-permeation side.

In contrast, according to the method for operating the gas separation device in the invention to which a batch-wise gas separation method is applied, a separation operation can be performed such that the separation performance of hydrogen is about 100% on the permeation side and the separation performance of monosilane is about 90% or higher (10% or lower of hydrogen) on the non-permeation side.

Additionally, in the case where usual polymer membranes are used as the gas separation membranes, a certain degree of permeation occurs even if the molecular diameter is about 4 Å or more. However, in the case of the carbon membranes used for the invention, permeation hardly occurs if the molecular diameter is about 4 Å or more, and permeation does not occur further if the molecular diameter becomes large. As such, the effects of the molecular sieving action can be expected in the carbon membranes rather than in the polymer membranes.

In addition, even if the carbon membranes are compared with other zeolite membranes or silica membranes with the molecular sieving action, the carbon membranes have excellent chemical resistance, and are suitable for the separation of a specialty gas used for the semiconductor field with strong corrosivity.

Moreover, the membrane module can be compactly designed compared to a flat membrane shape or a spiral shape by molding the carbon membranes in the shape of hollow fibers.

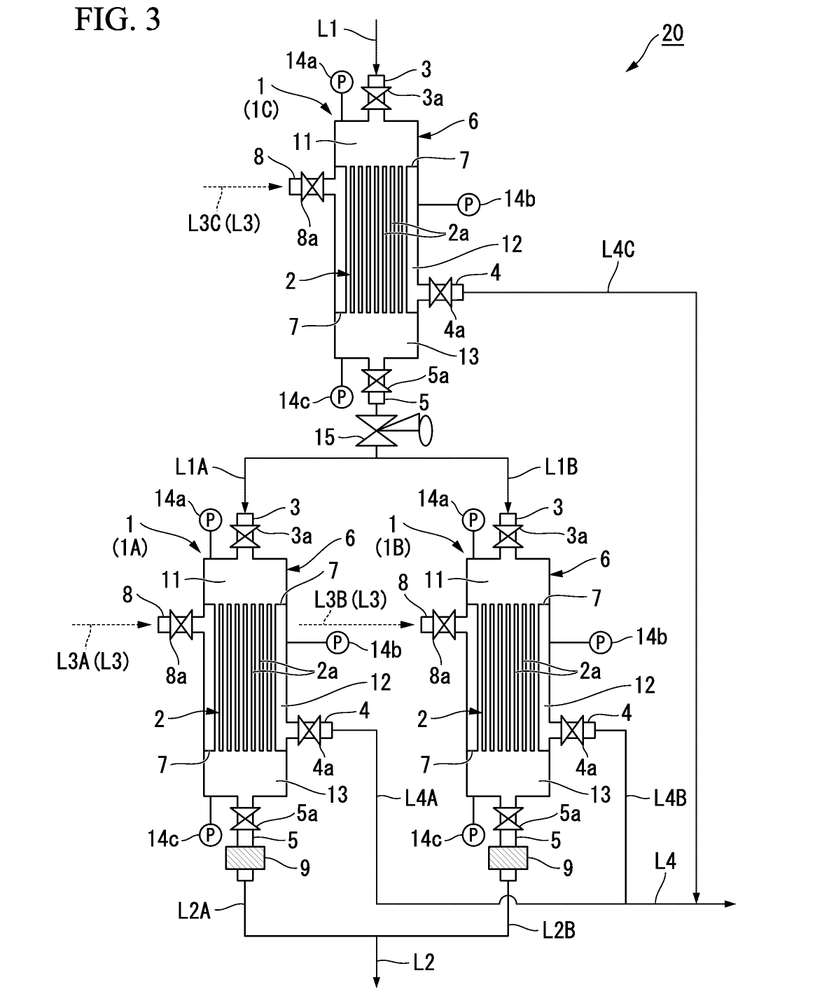

Next, another example of the form for carrying out the invention will be described below in detail with reference to FIG. 3.

In FIG. 3, reference numeral 20 designates a gas separation device. The gas separation device 20 of this example is schematically configured such that a separation membrane module 1C is connected in series to the preceding stage of the two carbon membrane modules 1A and 1B.

Additionally, the carbon membrane module 1C has the same configuration as the carbon membrane modules 1A and 1B except that a back pressure valve 15 is provided instead of a flow meter 9.

In the method for operating the gas separation device 20 of this example, first, a mixed gas is continuously supplied to the carbon membrane module 1C provided at the preceding stage, and a dilution gas (gas component with a small molecular diameter) is roughly separated and treated from the mixed gas.

Specifically, as shown in FIG. 3, the setting value of the back pressure valve (pressure reducing valve) 15 installed in the non-permeated gas discharge port 5 on the high-pressure side (non-permeation side) of the separation membrane module 1C is set to a pressure lower than the supply pressure of the mixed gas, and the opening and closing valves 3a and 5a are opened to continuously supply the mixed gas. At this time, the opening and closing valve 8a of the sweeping gas supply port 8 on the low-pressure side (permeation side) is closed, and the opening and closing valve 4a of the permeated gas discharge port 4 on the discharge side is open.

Thereby, only the dilution gas that is a gas component with a small molecular diameter in the mixed gas supplied to the non-permeation side is caused to permeate into the low-pressure side of the carbon membrane unit 2 selectively and preferentially according to the pressure differential between the high-pressure side and the low-pressure side, and the mixed gas containing the hydride gas that is a gas component with a large molecular diameter is continuously discharged from the non-permeated gas discharge port 5.

In this way, according to the method for operating the gas separation device of this example, the above-described continuous batch treatment is performed by the two carbon membrane modules 1A and 1B connected in parallel at the subsequent stage after the carbon membrane module 1C at the preceding stage performs rough refining of the mixed gas. Therefore, the mixed gas in which the hydride gas is concentrated can be supplied to the carbon membrane modules 1A and 1B at the subsequent stage. It is thereby possible to reduce (shorten the separation time and improve the separation capability) a burden on the carbon membrane modules disposed at the subsequent stage.

Additionally, since the mixed gas in which the hydride gas is concentrated can be supplied to the carbon membrane modules 1A and 1B at the subsequent stage, the operation cycles of the carbon membrane modules 1A and 1B can be shortened in a case where the same supply flow rate as that in a case where the carbon membrane module 1C is not arranged at the preceding stage is adopted. This is because the concentration of the hydride gas in the supply gas is increasing, and thus, 0.2 MPaG is reached in a short time as compared to a case where the carbon membrane module 1C at the preceding stage is not provided.

Additionally, the supply pressure when the third process is started, and the non-permeation pressure can be kept high.

This is because the concentration of hydrogen that is the dilution gas in the supply gas is low, and thus, the gas separation is completed with a high pressure value in the second process. Since the retaining pressure on the non-permeation side is high in this way, the non-permeated gas is taken out at a large flow rate.

In addition, it should be understood that the technical scope of the invention is not limited to the above embodiment, but various modifications can be made without departing from the spirit and scope of the invention. For example, in the examples of the above-described embodiment, two carbon membrane modules are connected in parallel. However, the invention is not particularly limited, and three or more carbon membrane modules may be connected in parallel. Additionally, a form in which two or more carbon membrane modules are connected in series to form an inside unit, and two or more of the units are connected in parallel may be adopted.

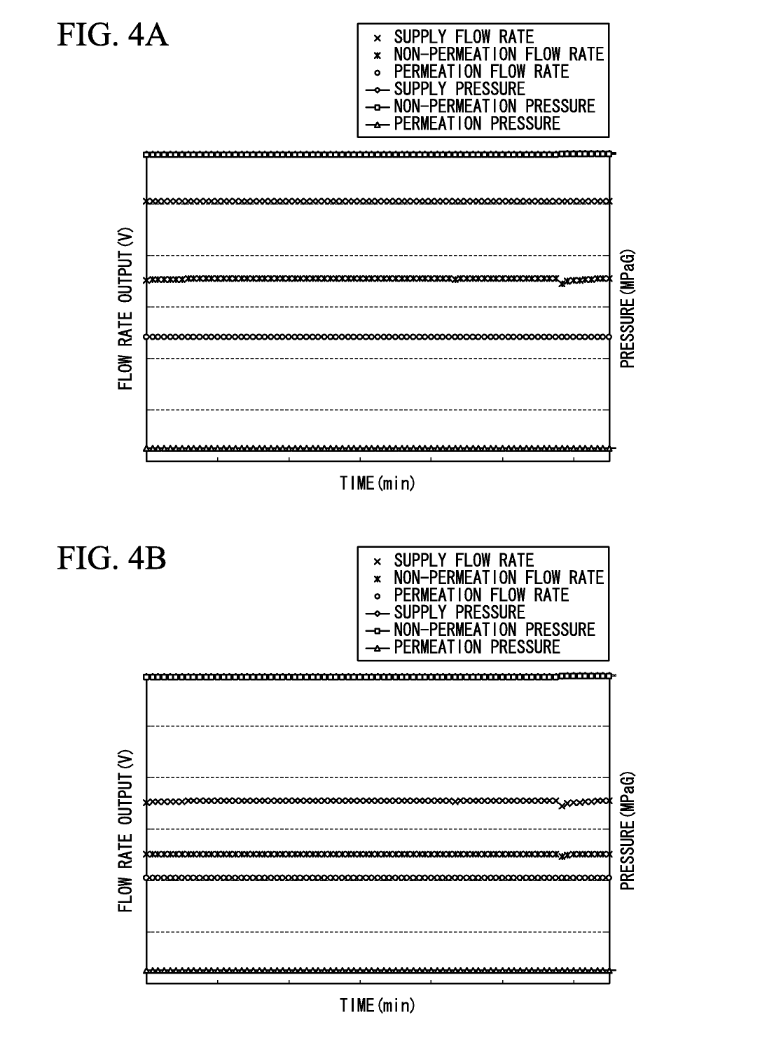

In a case where carbon membrane modules having the same performance are connected in series, separation operation is not performed in a batch manner, but separation operation is performed only in a continuous manner. FIGS. 4A and 4B are timing charts in a case where two carbon membrane modules are connected in series and separation operation is performed in a continuous manner.

Since separation operation is performed in a continuous manner, there is almost no difference between a first (see FIG. 4A) stage and a second (see FIG. 4B) stage regarding the supply pressure, the non-permeation pressure, and the permeation pressure. However, the supply flow rate, the non-permeated flow rate, the permeation flow rate have small values on the whole because the discharge gas at the first stage becomes the supply gas at the second stage.

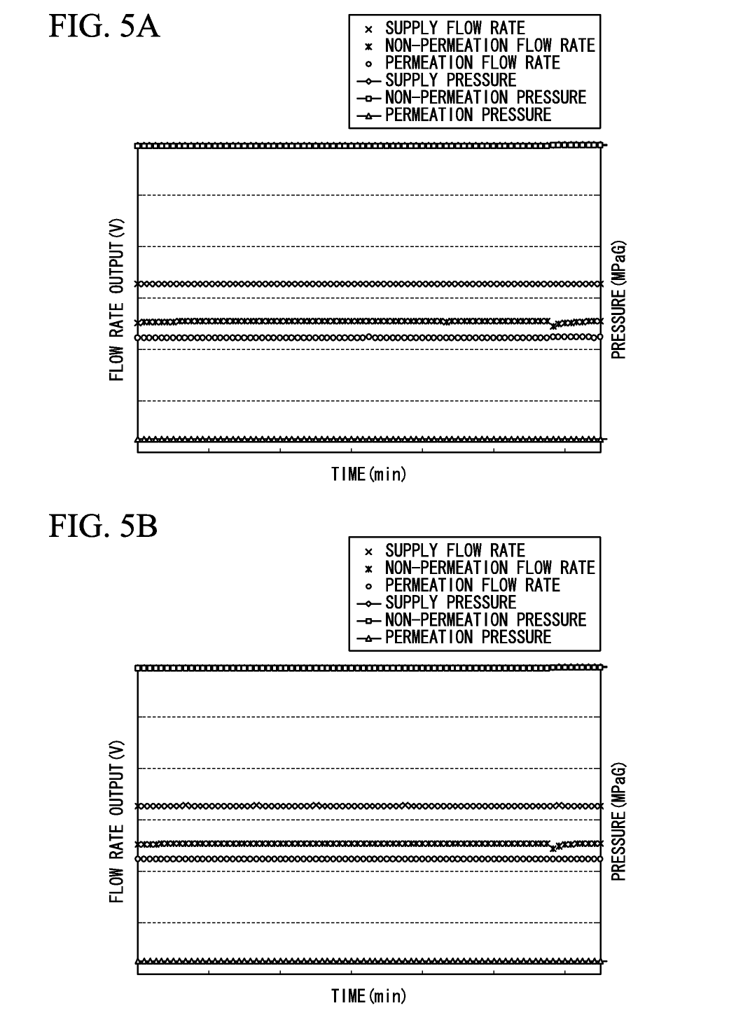

On the other hand, in a case where carbon membrane modules having the same performance are connected in parallel, it is also possible to perform separation operation in a continuous manner in addition to performing separation operation in a batch manner. FIGS. 5A and 5B are timing charts in a case where two carbon membrane modules are connected in parallel and separation operation is performed in a continuous manner.

Since separation operation is performed in a continuous manner, there is no difference between one module (see FIG. 5A) arranged in parallel and the other module (see FIG. 5B) arranged in parallel, regarding any of the supply pressure, the non-permeation pressure, the supply flow rate, the permeation flow rate, the non-permeated flow rate, and the permeation pressure.

Refining means may appropriately be provided at the preceding stage and/or the subsequent stage of a gas separation membrane device in which a plurality of carbon membrane modules is connected in parallel. In the gas separation device 20 of FIG. 3, the carbon membrane module 1C is provided at the preceding stage in order to perform rough separation treatment. Here, the refining means includes TSA, PSA, distillation refining, low-temperature refining, wet scrubbers, or the like, using an adsorption column or a catalyst tube. Particularly, as the refining means at the preceding stage, it is preferable not to exert an influence on continuously supplying the mixed gas to a plurality of carbon membrane modules connected in parallel and performing separation operation in the batch manner of the gas separation membrane device (setting of treatment time, cycle process, or the like).

The merits resulting from separately providing the generating means at the preceding stage and/or the subsequent stage are as follows.

(1) The life-span of the gas separation membrane device is raised by removing impurities that affect the gas separation membrane device.

(2) The purity of the gas recovered from the gas separation membrane device can be further enhanced by removing impurities that cannot be separated in the gas separation membrane device.

(3) A burden on the gas separation membrane device can be reduced (the separation membrane time can be shortened, and the separation capability is improved) by performing rough refining, before entering the gas separation membrane device.

Moreover, in the examples of the above-described embodiment, the operation cycles of the two carbon membrane modules connected in parallel are shifted by a ½ cycle. However, the operation cycles may be values other than this, and the cycles may not be shifted.

When a plurality of carbon membrane modules is connected in parallel and continuous separation operation is in a batch manner, the integral value (N) more than or equal to a value obtained by dividing the required time (T) for one cycle by the required time (T₁) for the first process is needed as the number of required carbon membrane modules.

N≧/T₁ (6)

When a plurality of carbon membrane modules are connected in parallel and continuous separation operation is performed in a batch manner, T₁=½ T may not be established.

In this case, the required time (T₃) for the third process is given by adding the adjustment time for which the gas separation membrane device is required to perform continuous separation operation in a batch manner, to the time required for a process in which the mixed gas is recovered from the non-permeated gas discharge port.

The adjustment time is determined as follows.

For example, in the case of T₁=3, T₂=20, T₃=5, and T=28, N≧9.333 . . . is obtained from Expression (6), and the number of carbon membrane modules becomes 10.

After the first process is completed in a first carbon membrane module, the first process begins sequentially in the second, third, . . . , carbon membrane modules. One cycle of the first carbon membrane module is completed 1 minute after the first process begins in the last and tenth carbon membrane module. Here, since the tenth carbon membrane module is still in the middle of the first process, the gas separation membrane device can perform continuous separation operation in a batch manner by providing T₃ of the first carbon membrane module with 2 minutes of adjustment time (standby time).

The carbon membrane modules after the second carbon membrane module also add adjustment time similarly to the first carbon membrane module.

In the method for operating the gas separation device in the invention, the temperature (operating temperature) at which the above separation operation is performed is not particularly limited and can be appropriately set according to the separation performance of the separation membranes.

Here, the operating temperature is given assuming the ambient temperature of each carbon membrane module, and a temperature range of −20° C. to 120° C. is suitable. If the operating temperature is made to be high, the permeation flow rate can be increased, and the treatment time of the batch operation can also be shortened.

In a batch-wise gas separation method used in the invention, the pressure (operation pressure) (on high-pressure side of the carbon membrane unit 2) is not particularly limited, and can be appropriately set according to the separation performance of the separation membranes. Specifically, the pressure of the gas supplied to the carbon membrane module 1 (1A, 1B) can be set to be higher than or equal to 1 MPaG; if a support is used. Usually, the pressure of about 0.5 MPaG is retained. This support is a member that keeps the hollow fiber-like carbon membranes 2a . . . from being crushed. If the operation pressure is made high, the permeation flow rate can be increased, and the treatment time of the batch operation can also be shortened.

In order to control the operation pressure, in a continuous gas separation method of the related art, a back pressure valve or the like is installed in the non-permeated gas discharge port.

In contrast, in the batch-wise gas separation method used in the invention, it is not necessary to particularly provide the back pressure valve in order to control the operation pressure. In the example shown in FIG. 1, the operation pressure can be controlled by closing the opening and closing valve 5a of the non-permeated gas discharge port 5. When the non-permeated gas retained on the non-permeation side is taken out, the separation membranes may be greatly damaged if the opening and closing valve 5a of the non-permeated gas discharge port 5 is opened freely (at one time). For this reason, it is preferable to provide the non-permeated gas discharge port 5 with the flow meter 9 or the like, to take out the non-permeated gas at a constant flow rate.

Additionally, in the carbon membrane module 1 shown in FIG. 1, the second space 12 that is the low-pressure side (permeation side) of the carbon membrane unit 2 is preferably vacuumed. Vacuuming the second space 12 also has an effect that the pressure differential between the high-pressure side (non-permeation side) of the carbon membrane unit 2 and the low-pressure side (permeation side) of the carbon membrane unit 2 is increased, but can particularly increase the pressure ratio between the high-pressure side (non-permeation side) of the carbon membrane unit 2 and the low-pressure side (permeation side) of the carbon membrane unit 2. In addition, although it is preferable that both the pressure differential and the pressure ratio be large for the separation performance of the separation membranes, the pressure ratio is more preferable for the separation performance.

Additionally, in the carbon membrane module 1 shown in FIG. 1, the same effects as the vacuuming are obtained even by passing the sweeping gas to the low-pressure side (permeation side) of the carbon membrane unit 2. The opening and closing valve of the sweeping gas supply port 8 is opened to supply the sweeping gas into the second space 12 at a predetermined flow rate.

In addition, the gas on the permeation side can also be efficiently recovered by making the sweeping gas having the same component (that is, the dilution component of the mixed gas) as the permeated gas. Additionally, a portion of permeated gas recovered from the permeated gas discharge port 4 may be used as the sweeping gas.

In the batch-wise gas separation method used in the invention, for example, in the case of the above hollow fiber-like separation membranes, two patterns including a case (core-side supply) where a high-pressure gas is supplied into hollow fiber-like separation membranes and a case where a high-pressure gas is supplied to the surroundings of the hollow fiber-like separation membranes (outside supply) can be considered as a form in which the mixed gas is supplied to the carbon membrane module 1. However, since the core-side supply allows operation with more improved separation performance as shown in FIG. 1, this is preferable.

In the batch-wise gas separation method used in the invention, in order to increase the amount of gas treatment per one carbon membrane module, there are methods, such as increasing the membrane area (in the case of the hollow fiber-like separation membranes, the number of the membranes is increased) and reducing the volume of the space second space 12. In the latter case, it is necessary to devise a structure within the space or to add a mixer in order to cause the gas and the separation membranes to sufficiently contact each other.

### Second Embodiment

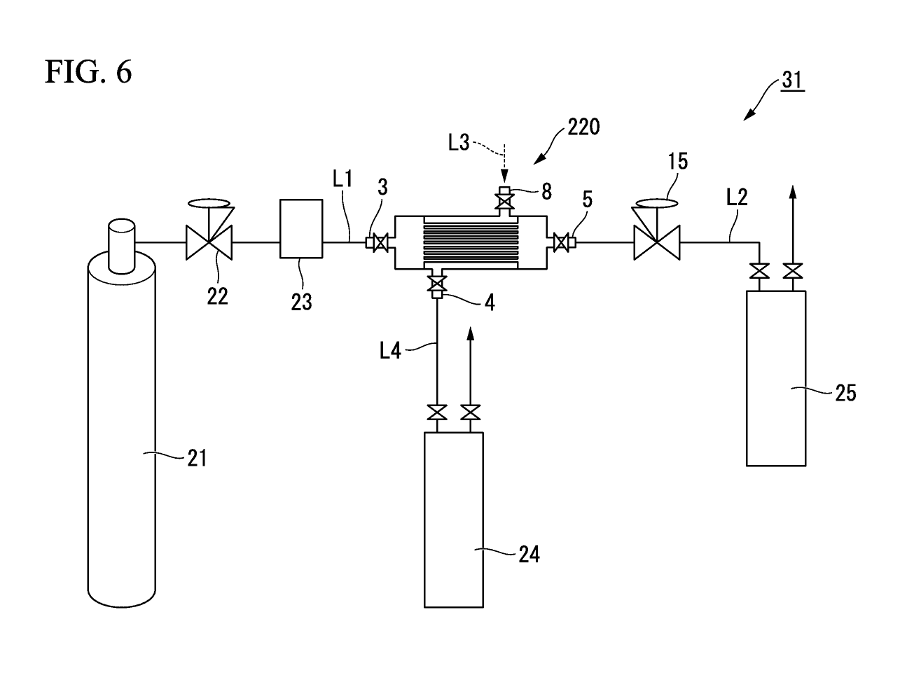

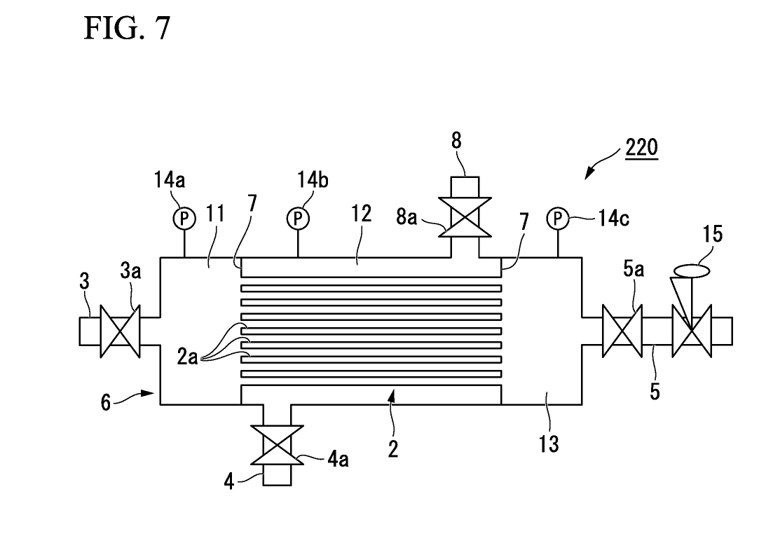

A second embodiment to which the invention is applied will be described below in detail with reference to FIGS. 6 and 7.

An example of a recovery device used for a method for recovering the residual gas that is the second embodiment to which the invention is applied is shown in FIG. 6. In addition, in the example of the recovery device, a carbon membrane module is used as an example of a separation membrane module. Additionally, in this carbon membrane module, a carbon membrane is used as the gas separation membrane.

As shown in FIG. 6, the recovery device 31 of the present embodiment is schematically configured so as to include a cylinder 21 in which a mixed gas that serves as a target to be separated and recovered remains, a carbon membrane module 220 that separates the mixed gas, and recovery facilities 24 and 25 that recover separated gas components.

Specifically, the cylinder 21, and a supply port 3 provided in the carbon membrane module 220 are connected together by the mixed gas supply path L1. A pressure reducing valve 22 and a flow meter 23 are disposed in the mixed gas supply path L1. This allows the mixed gas remaining within the cylinder 21 to be supplied to the carbon membrane module 220 while controlling pressure and flow rate.

Additionally, the permeated gas discharge port 4 provided in the carbon membrane module 220, and the recovery facility 24 are connected together by the permeated gas discharge path (permeated gas recovery path) L4. This makes it possible to recover a permeated gas component separated by the carbon membrane module 220 in the recovery facility 24.

Additionally, the non-permeated gas discharge port 5 provided in the carbon membrane module 220, and the recovery facility 25 are connected together by the non-permeated gas path (non-permeated gas recovery path) L2. This makes it possible to recover a non-permeated gas component separated by the carbon membrane module 220 in the recovery facility 25.

Moreover, the sweeping gas supply port 8 provided in the carbon membrane module 220 is connected to a sweeping gas supply source (not shown). This enables the sweeping gas to be supplied into the carbon membrane module.

As shown in FIG. 7, the carbon membrane module 220 is generally constituted by the airtight container 6 and the carbon membrane unit (gas separation membranes) 2 provided within the airtight container 6. In the carbon membrane module of the present embodiment, the same constituent portions as the first embodiment are designated by the same reference numerals, and a description thereof is omitted here.

Next, a method for recovering a residual gas in the present embodiment, using the recovery device 31 shown in FIG. 6, will be described.

The method for recovering a residual gas in the present embodiment is a method for continuously supplying the mixed gas remaining in the cylinder 21 to the separation membrane module including the separation membranes having the molecular sieving action, separating the mixed gas into a gas component with a small molecular diameter and a gas component with a large molecular diameter, and then, recovering the gas component with a small molecular diameter and the gas component with a large molecular diameter in the recovery facilities 24 and 25, respectively. In the present embodiment, a case where a separation membrane module is adopted as the carbon membrane module 220 having the molecular sieving action, and a mixed gas of a dilution gas and a hydride gas is adopted as the mixed gas that serves as a target to be separated will be described. Here, the molecular sieving action is an action by which the mixed gas is separated into a gas with a small molecular diameter and a gas with a large molecular diameter depending on the size of the molecular diameters of gases and the diameter of pores of the separation membranes.

The gases that serve as targets to be separated and recovered in the present embodiment are mixed gases in which specialty gases represented by hydride gases, such as monosilane, monogermane, arsine, phosphine, and hydrogen selenide, or rare gases, such as xenon and krypton, are diluted and mixed by dilution gases, such as hydrogen and helium.

Here, the dilution gases, such as hydrogen and helium, are gas components with a comparatively small molecular diameter, and hydride gases, such as monosilane and monogermane and the rare gases, such as xenon, krypton, can be classified into gas components with a comparatively large molecular diameter.

That is, the mixed gas that is a target to be separated and recovered is a mixture of two or more components including a gas component with a small molecular diameter and a gas component with a large molecular diameter. As long as there is a difference in molecular diameter between these gas components, combinations of any kinds of gas components may be adopted. If the difference in molecular diameter between these components is larger, the treatment time required for separation operation can be further shortened.

As the gas component with a small molecular diameter in the mixed gas, it is preferable to use gas components in which the molecular diameter is less than or equal to 3 Å. In contrast, as the gas component with a large molecular diameter in the mixed gas, a gas component in which the molecular diameter is more than 3 Å, preferably more than or equal to 4 Å, and more preferably more than or equal to 5 Å may be adopted.

The mixed gas is not limited to a two-component system, and may be obtained by mixed a plurality of gas components. In order to sufficiently separate respective gas components to either the permeation side or the non-permeation side of the separation membrane, it is preferable to roughly sort the gas components into a gas component group with a large molecular diameter and a gas component group with a small molecular diameter. The diameter of pores of the carbon membranes may be between the molecular diameter of the gas component group with a large molecular diameter and the molecular diameter of the gas component group with a small molecular diameter. In addition, the diameter of the pores of the carbon membranes can be adjusted by changing the combustion temperature during carbonization.

Additionally, the residual gas remaining in the cylinder 21 is usually lower than or equal to 1 MPaG in many cases. In the method for recovering a residual gas in the present embodiment, this residual gas is supplied to the carbon membrane unit 2 and retained at a suitable separation and recovery pressure by the back pressure valve 15 installed at the subsequent stage of the carbon membrane module 220, a molecular sieving action is exerted by using the pressure differential between the non-permeation side and the permeation side of the carbon membrane module 220, as a driving source that moves molecules of a gas component, thereby performing separation of the mixed gas.

Next, the gas separation operation using the carbon membrane module 220 shown in FIG. 7 will be described.

Specifically, as shown in FIG. 7, first, the opening and closing valve 5a provided in the non-permeated gas discharge port 5 on the high-pressure side (non-permeation side) of the carbon membranes is opened, and the back pressure valve 15 is set to an adjusted pressure. Then, the opening and closing valve 3a of the mixed gas supply port 3 is opened to supply the mixed gas into the carbon membrane module 220 and fill the module with pressure until a predetermined pressure is reached from a low pressure state. At this time, the opening and closing valve of the sweeping gas supply port 8 on the low-pressure side (permeation side) of the carbon membrane module 220 is closed, and the opening valve 4a of the permeated gas discharge port 4 is open. Thereby, only a gas component with a small molecular diameter in the mixed gas supplied to the non-permeation side (the first space 11) can be made to permeate into the low-pressure side (the second space 12) of the carbon membrane module 220 selectively and preferentially and can be discharged from the permeated gas discharge port 4. On the other hand, the mixed gas containing a high proportion of a gas component with a large molecular diameter can be discharged from the non-permeated gas discharge port 5.

Here, if the mixed gas is supplied to the carbon membrane module 220 from the cylinder 21, the pressure of the cylinder 21 drops. In this case, separation and recovery can be efficiently performed even if the pressure on the supply side (non-permeation side) becomes close to the atmospheric pressure by vacuuming the permeation side of the carbon membrane module 220 or supplying the sweeping gas from the sweeping gas supply port 8, if necessary.

The gas component with a large molecular diameter, for example, hydride gas, such as monosilane or a rare gas such as xenon is concentrated and separated on the non-permeation side of the separation membranes through the separation and concentration operation using such a carbon membrane module 220. On the other hand, the gas component with a small molecular diameter, for example, a dilution gas component, such as hydrogen or helium, is continuously recovered from the permeation side of the separation membranes.

The concentrated and separated gas component, such as monosilane or xenon, is introduced into the recovery facility 25 installed at the subsequent stage. Then, the gas components are recovered and cooled as they are according to the properties of gases, and are appropriately recovered by liquefaction and recovery or gas recovery using a compressor or the like.

On the other hand, a gas component, such as hydrogen or helium, which is recovered in the recovery facility 24 on the permeation side is similarly recovered by a suitable recovery method.

In addition, the gas recovered in the recovery facility 24 and the gas recovered in the recovery facility 25 are subjected to detoxifying treatment or recycling according to their respective purposes.

As described above, according to the method for recovering a residual gas in the present embodiment, the mixed gas remaining in the returned cylinder 21 can be efficiently separated and recovered. This makes it possible to simply perform detoxifying treatment or recycling.

Additionally, since the present embodiment has a configuration in which a residual gas is continuously supplied from the cylinder 21 to the carbon membrane module 220, it is possible to separate and recover the residual gas through extremely simple operation.

### Third Embodiment

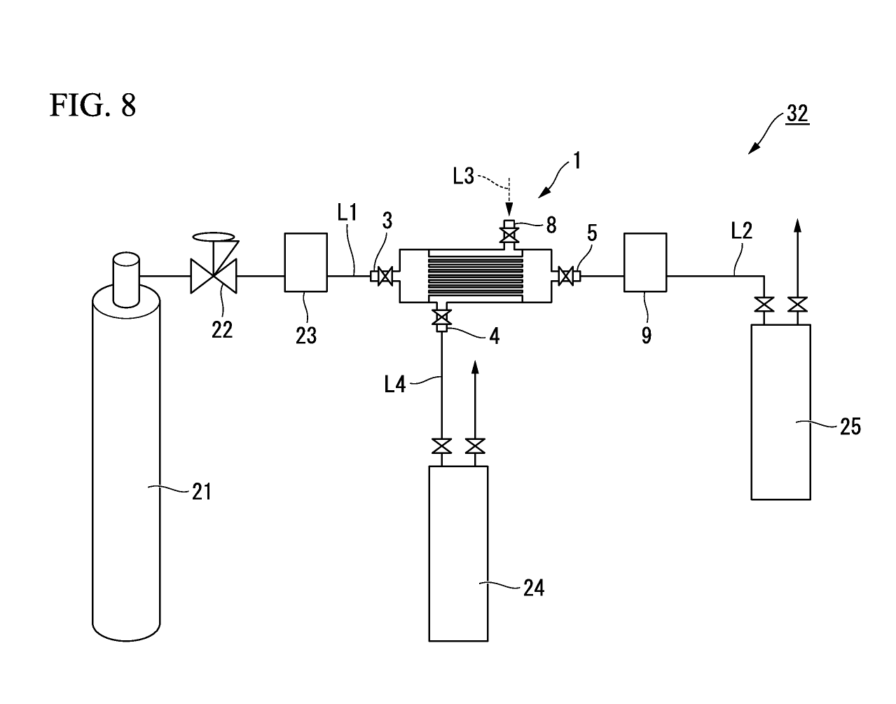

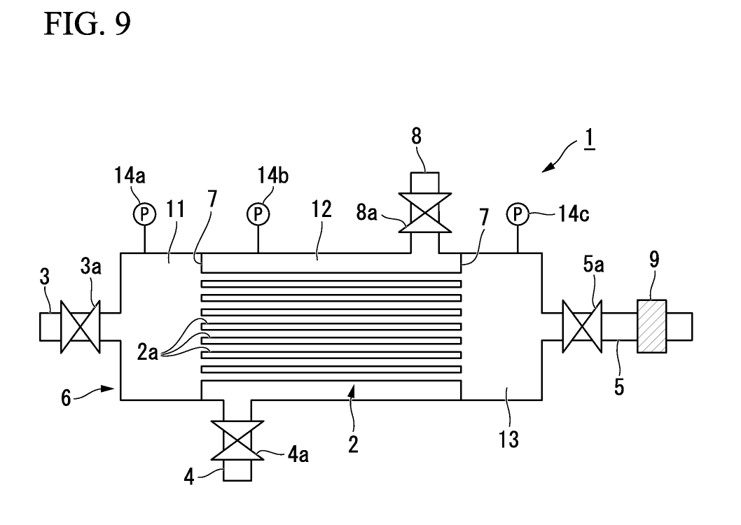

Next, a third embodiment to which the invention is applied will be described. The present embodiment has a configuration different from the method for recovering a residual gas in the second embodiment. For this reason, the method for recovering a residual gas in the present embodiment will be described with reference to FIGS. 8 and 9. As for the recovery device and the carbon membrane module that are used for recovery of a residual gas in the present embodiment, the same constituent portions as the second embodiment are designated by the same reference numerals, and a description thereof is omitted here.

A recovery device 32 used for the method for recovering a residual gas in the present embodiment shown in FIG. 8 is different from the recovery device 31 in the second embodiment shown in FIG. 6 in that the carbon membrane module 1 is used.

Additionally, as shown in FIG. 9, the carbon membrane module 1 used for the present embodiment is different from the carbon membrane module 220 in the second embodiment in that the flow meter 9 is installed instead of the back pressure valve 15 provided at the subsequent stage of the non-permeated gas discharge port 5.

Here, as a method of pressure control related to the separation membranes, it is general to install the back pressure valve 15 or the like at an outlet on the non-permeation side of the separation membranes, thereby performing this pressure control, in a case where membrane separation is continuously performed like the method for recovering a residual gas in the second embodiment.

In contrast, in the present embodiment, gas separation is performed in a batch manner as will be described later. Therefore, it is not necessary to particularly provide the back pressure valve for the pressure control of the separation membranes. As shown in FIG. 8, in the carbon membrane module 1 of the present embodiment, the pressure control of the gas separation membranes (carbon membrane unit 2) can be performed by closing the opening and closing valve 5a of the non-permeated gas discharge port 5.

In a case where the non-permeated gas retained on the non-permeation side of the gas separation membranes is taken out, it is preferable to provide the non-permeated gas discharge port 5 with the flow meter 9 or the like, to take out non-permeated gas at a suitable constant flow rate. If the opening and closing valve 5a of the non-permeated gas discharge port 5 is opened freely (at one time), and non-permeated gas is taken out without controlling the flow rate of the non-permeated gas, great damage may be caused to the separation membranes.

Next, a method for recovering a residual gas in the present embodiment, using the recovery device 32 shown in FIG. 8, will be described.

The method for recovering a residual gas in the present embodiment performs gas separation, using a method different from the second embodiment that continuously supplies a mixed gas from the cylinder 21 to the carbon membrane module 220.

In the method for recovering a residual gas in the present embodiment, the operation cycle including the first to fourth processes that have been described in the above-described first embodiment regarding the carbon membrane module 1 is continuously and repeatedly operated.

Incidentally, in the method for recovering a residual gas in the above-described second embodiment, for example, in a case where a mixed gas of 90% of hydrogen with a small molecular diameter and 10% of monosilane with a large molecular diameter is continuously supplied to carbon membranes that are the separation membranes, the separation performance of hydrogen is about 100% on the permeation side, and the separation performance of monosilane is about 60% (40% of hydrogen) on the non-permeation side.

In contrast, according to the method for recovering a residual gas in the present embodiment, using the batch-wise gas separation method, separation operation can be performed such that the separation performance of hydrogen is about 100% on the permeation side and the separation performance of monosilane is about 90% or higher (10% or lower of hydrogen) on the non-permeation side.

As described above, according to the method for recovering a residual gas in the present embodiment, the same effects as those of the above-described second embodiment can be obtained.

Additionally, since the present embodiment has a configuration using the batch-wise gas separation method, it is possible to perform operation with sufficient separation performance in a smaller membrane area than that of the second embodiment.

### Fourth Embodiment

Next, a fourth embodiment to which the invention is applied will be described. The present embodiment has a configuration different from the method for recovering a residual gas in the second and third embodiments. As for the recovery device and the carbon membrane module that are used for recovery of a residual gas in the present embodiment, the same constituent portions as those of the second and third embodiments are designated by the same reference numerals, and the description thereof is omitted.

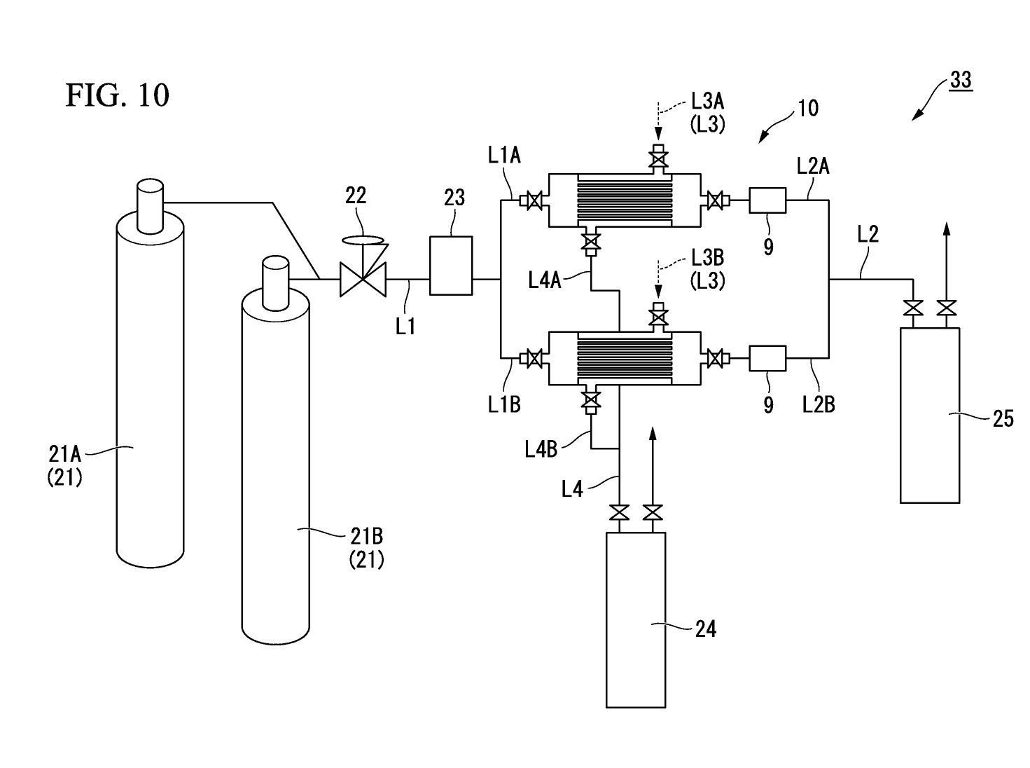

There is a difference in that the recovery devices 31 and 32 of the second and third embodiments uses the carbon membrane module independently, whereas the recovery device 33 used for the method for recovering a residual gas in the present embodiment uses the gas separation device (carbon membrane module unit) 10 including the two carbon membrane modules 1A and 1B as shown in FIG. 10. Additionally, there is a difference in that the recovery devices 31 or 32 of the second and third embodiments is connected to one cylinder 21, whereas the recovery device 33 of the fourth embodiment is connected two cylinders.

As shown in FIG. 1, the carbon membrane module used for the present embodiment constitutes the carbon membrane module unit 10 in which the two carbon membrane modules 1A and 1B are connected in parallel by the paths L1A to L4A and the paths L1B to L4B that branch from the paths L1 to L4.

Next, a method for recovering a residual gas in the present embodiment, using the recovery device 33 including the above-described carbon membrane module unit 10, will be described.

In the method for recovering a residual gas in the present embodiment, first, the operation cycle including the first to fourth processes that have been described in the above-described third embodiment regarding, for example, the carbon membrane module 1A among the carbon membrane modules connected in parallel is continuously and repeatedly operated.

Next, the other carbon membrane module 1B connected to this one carbon membrane module 1A in parallel is operated in the same operation cycle shifted by a predetermined interval with respect to the operation cycle of the carbon membrane module 1A.

Specifically, in a case where two carbon membrane modules are connected with each other in parallel, it is preferable to shift the phase of the operation cycle of the carbon membrane module 1B with respect to that of the carbon membrane module 1A by a ½ cycle.

Moreover, in a case where two carbon membrane modules are connected with each other in parallel and are operated with their operation cycles being shifted by a ½ cycle, it is preferable to satisfy the relationship of T₁=½T, that is, T_{I}=T₂+T₃ in the above Expression (5).

In addition, if the mixed gas is first supplied to the carbon membrane module unit 10 from a cylinder 21A and the residual pressure of this cylinder 21A decreases, the mixed gas can be continuously supplied to the carbon membrane module unit 10 by being switched to a cylinder 21B. Additionally, the cylinder 21A of which the recovery is completed can be removed and attached to the next cylinder.

As described above, according to the method for recovering a residual gas in the present embodiment, the same effects as those of the above-described third embodiment can be obtained.

Additionally, since the present embodiment has a configuration using the carbon membrane module unit in which two carbon membrane modules are connected with each other in parallel, it is possible to perform continuous separation operation as the whole recovery device 33.

In addition, it should be understood that the technical scope of the invention is not limited to the above embodiments, but various modifications can be made without departing from the spirit and scope of the invention. For example, in the recovery device 33 of the above-described fourth embodiment, two carbon membrane modules are connected with each other in parallel. However, the invention is not particularly limited, and three or more carbon membrane modules may be connected with each other in parallel. Additionally, a form in which two or more carbon membrane modules are connected with each other in series to form an inside unit, and two or more of the units are connected with each other in parallel may be adopted.

The number of required separation membrane modules and adjustment time when a plurality of carbon membrane modules are connected with each other in parallel and continuous separation operation is performed in a batch manner are as described in the first embodiment.

In a case where the used cylinder filled with a diluted mixed gas is returned, it is general to return the cylinder, with some gas being left within the cylinder as the residual gas. The cylinder pressure (residual gas pressure) when being returned is various depending on the intended purpose of the diluted mixed gas, dilution gases, and the kind of gases to be diluted. The residual gas pressure is generally 1 MPaG even if high, and is usually about 0.5 MPaG.

In the method for recovering a residual gas in the present embodiment, the residual gas pressure itself becomes an operation pressure for performing separation in the separation membranes. For this reason, when the residual gas pressure is high, it is possible to perform separation very efficiently and to perform separation with excellent separation performance. However, if the residual gas pressure drops, it becomes difficult to perform separation efficiently, and consequently, degradation of the separation performance is brought about.

If the continuous gas separation method is compared with the batch-wise gas separation method from a viewpoint of the residual gas pressure, the former method is influenced by the residual gas pressure more than the former method. Although the latter method is slightly influenced, the separation performance can be maintained by increasing the occupying ratio of the second process with respect to the whole stroke (lengthening the time required for the second process to a certain degree).

Although the former method is greatly influenced, it is possible to maintain the separation performance as much as possible, by decreasing the flow rate of the supply gas (non-permeated gas) according to degradation of the back pressure, using the flow meter 9.

In the method for recovering a residual gas in the invention, the temperature (operating temperature) and pressure where the above separation operation of the carbon membrane modules is performed are as described in the first embodiment.

Additionally, in the above-described third and fourth embodiments, in the carbon membrane module 1 shown in FIG. 9, the second space 12 that is the low-pressure side (permeation side) of the carbon membrane unit 2 is preferably vacuumed. Vacuuming the second space 12 also has an effect that the pressure differential between the high-pressure side (non-permeation side) of the carbon membrane unit 2 and the low-pressure side (permeation side) of the carbon membrane unit 2 is increased, but can particularly increase the pressure ratio between the high-pressure side (non-permeation side) of the carbon membrane unit 2 and the low-pressure side (permeation side) of the separation membrane unit 2. In addition, although it is preferable that both the pressure differential and the pressure ratio be large for the separation performance of the separation membranes, the pressure ratio being large is more preferable for the separation performance.

Additionally, in the carbon membrane module 1 shown in FIG. 9, the same effects as the vacuuming are obtained even by passing the sweeping gas to the low-pressure side (permeation side) of the carbon membrane unit 2. The opening and closing valve of the sweeping gas supply port 8 is opened to supply the sweeping gas into the second space 12 at a predetermined flow rate.

In addition, the gas on the permeation side can also be efficiently recovered by making the sweeping gas having the same component (that is, the dilution component of the mixed gas) as the permeated gas. Additionally, a portion of permeated gas recovered from the permeated gas discharge port 4 may be used as the sweeping gas.

In the method for recovering a residual gas in the invention, for example, in the case of the above hollow fiber-like separation membranes, two patterns including a case (core-side supply) where a high-pressure gas is supplied into hollow fiber-like separation membranes and a case where a high-pressure gas is supplied to the surroundings of the hollow fiber-like separation membranes (outside supply) can be considered as a form in which the mixed gas is supplied to the carbon membrane module 1 or 220. However, since the core-side supply allows operation with more improved separation performance as shown in FIGS. 7 and 9, this is preferable.

In the method for recovering the residual gas in the invention, in order to increase the amount of gas treatment per one carbon membrane module 1, there are methods, such as increasing the membrane area (in the case of the hollow fiber-like carbon membranes, the number of the membranes is increased) and reducing the volume of the second space 12. In the latter case, it is necessary to devise the structure within the space or to add a mixer in order to cause the gas and the separation membranes to sufficiently contact each other.

Specific examples will be shown below. However, the invention is not limited by the following examples at all.

### Example A1

Batch-wise gas separation was performed using the separation membrane modules shown in FIG. 1. In addition, those having the same specification were used as the two separation membrane modules, and there were no particular individual differences even in the performance of the modules.

A mixed gas was supplied to the separation membrane modules in a batch manner under the following conditions, and three cycles were performed. As a result, the discharge pressure was 0.12 MPaG. As for the breakdown of the time required for one cycle, the first process (supply process) was about 7 minutes, the second process (separation process) was about 5 minutes, and the third process (discharge process) was about 2 minutes. Additionally, gas compositions on the non-permeation side and the permeation side were measured, respectively. In addition, gas chromatography (GC-TCD) with a thermal conductivity detector was used for measurement of volume concentration. The results are shown in Table 1.

(Separation Membrane Module)
Hollow fiber-like carbon membrane tubes
Total surface area of the tubes: 1114 cm²
Retained at 25° C.

(Mixed gas)
Mixed gas composition: 10.3 vol. % of monosilane and 89.7 vol. % of hydrogen

(Operation conditions)
Supply gas flow rate: supply of the mixed gas at about 150 sccm
Filling pressure: 0.2 MPaG
Permeation-side pressure: −0.088 MPaG (a vacuum-pump, a vacuum generator, or the like is utilized)
Discharge gas flow rate: about 100 sccm

### Comparative Example A1

Continuous gas separation was performed using the separation membrane modules shown in FIG. 1. In addition, those having the same specification were used as the two separation membrane modules, and there were no particular individual differences even in the performance of the modules.

A mixed gas was continuously supplied to the separation membrane modules under the following conditions. Additionally, gas compositions on the non-permeation side and the permeation side were each measured. In addition, gas chromatography (GC-TCD) with a thermal conductivity detector was used for measurement of volume concentration. The results are shown in Table 1.

(Separation Membrane Module)
Hollow fiber-like carbon membrane tubes
Total surface area of the tubes: 1114 cm²
Retained at 25° C.

(Mixed Gas)
Mixed gas composition: 10.3 vol. % of monosilane and 89.7 vol. % of hydrogen

(Operation Conditions)
Supply gas flow rate: supply of the mixed gas at about 150 sccm and supply of the mixed gas to one carbon membrane module at about 75 sccm
Discharge pressure: 0.2 MPaG (not the flow meter 9 but a back pressure valve is used)
Permeation-side pressure: −0.088 MPaG (a vacuum-pump, a vacuum generator, or the like is utilized)

### Comparative Example A2

Two separation membrane modules were connected in series, and continuous gas separation was performed. In addition, those having the same specification were used as the two separation membrane modules, and there were no particular individual differences even in the performance of the modules.

A mixed gas was continuously supplied to the separation membrane modules under the following conditions. Additionally, gas compositions on the non-permeation side and the permeation side were measured, respectively. In addition, gas chromatography (GC-TCD) with a thermal conductivity detector was used for measurement of volume concentration. The results are shown in Table 1.

(Separation Membrane Module)
Hollow fiber-like carbon membrane tubes
Total surface area of the tubes: 1114 cm²
Retained at 25° C.

(Mixed Gas)
Mixed gas composition: 10.3 vol. % of monosilane and 89.7 vol. % of hydrogen

(Operation Conditions)
Supply gas flow rate: supply of the mixed gas at about 150 sccm, the mixed gas is supplied to the first carbon membrane module at about 150 sccm, and the mixed gas discharged from the non-permeation side of the first carbon membrane module is supplied to the second carbon membrane module.
Discharge pressure: 0.2 MPaG (not the flow meter 9 but a back pressure valve is used)
Permeation-side pressure: −0.088 MPaG (a vacuum-pump, a vacuum generator, or the like is utilized)

TABLE 1

| | | Non-Permeated | | Permeated | | Total Discharge |
|---|---|---|---|---|---|---|
| | | Gas Composition | | Gas Composition | | Amount in One |
| | | (vol. %) | | (vol. %) | | Cycle (for 14 |
| | Supply Method | Hydrogen | Monosilane | Hydrogen | Monosilane | Minutes) |
| Example A1 | Parallel Batch | 0.125 | 0.875 | More than or | Less than 0.002 | 91.7 |
| | Type | | | Equal to 0.998 | | |
| Comparative | Parallel | 0.347 | 0.653 | More than or | Less than 0.002 | 345.8 |
| Example 1 | Continuous | | | Equal to 0.998 | | |
| | Type | | | | | |
| Comparative | Series | 0.187 | 0.813 | More than or | Less than 0.002 | 280 |
| Example 2 | Continuous | | | Equal to 0.998 | | |
| | Type | | | | | |

As shown in Table 1, in Example A1 in which the parallel batch-wise gas separation was performed, the concentration of monosilane in the non-permeated gas composition could be improved greatly compared with Comparative Example A1 in which the parallel continuous gas separation was performed.

A result was brought about in which the total discharge amount in one cycle (for 14 minutes) was the lowest in Example A1 in which the parallel batch-wise gas separation was performed.

In Comparative Example A1 in which the parallel continuous gas separation was performed and in Comparative Example A2 in which the series continuous gas separation was performed, supply was performed always at 0.2 MPaG in the supply process. However, in Example A1 in which the parallel batch-wise gas separation was performed, supply was performed at respective pressures from 0 MPaG to 0.2 MPaG per one cycle. Therefore, a difference in the supply amount of the mixed gas was caused as a difference in the discharge amount.

All the total surface areas of the carbon membrane of Example A1 in which the parallel batch-wise gas separation was performed, Comparative Example A1 in which the parallel continuous gas separation was performed, and Comparative Example A2 in which the series continuous gas separation was performed were the same.

If the membrane areas were the same, in Example A1 in which the parallel batch-wise gas separation was performed, hydride gas (monosilane) could be concentrated in the highest concentration.

On the other hand, if concentration to the same concentration is made by the parallel batch-wise gas separation, the parallel continuous gas separation, and the series continuous gas separation, operation can be performed with the total surface area of the carbon membranes when the parallel batch-wise gas separation is performed.

### Example B1

Recovery (continuous gas separation) of a residual gas was performed using the separation membrane module shown in FIG. 7.

A mixed gas was continuously supplied to the separation membrane module under the following conditions. Additionally, gas compositions on the non-permeation side and the permeation side were measured, respectively. In addition, gas chromatography (GC-TCD) with a thermal conductivity detector was used for measurement of volume concentration. The results are shown in Table 2.

(Separation Membrane Module)
Hollow fiber-like carbon membrane tubes
Total surface area of the tubes: 1114 cm²
Retained at 25° C.

(Mixed Gas)
Mixed gas composition: 10.3 vol. % of monosilane and 89.7 vol. % of hydrogen

(Operation Conditions)
Supply gas flow rate: supply of the mixed gas at about 150 sccm
Residual gas initial pressure: 0.2 MPaG
Permeation-side pressure: −0.088 MPaG (a vacuum-pump, a vacuum generator, or the like is utilized)
Back pressure valve: set to a value equal to or slightly lower than a residual gas pressure according to the residual gas pressure.

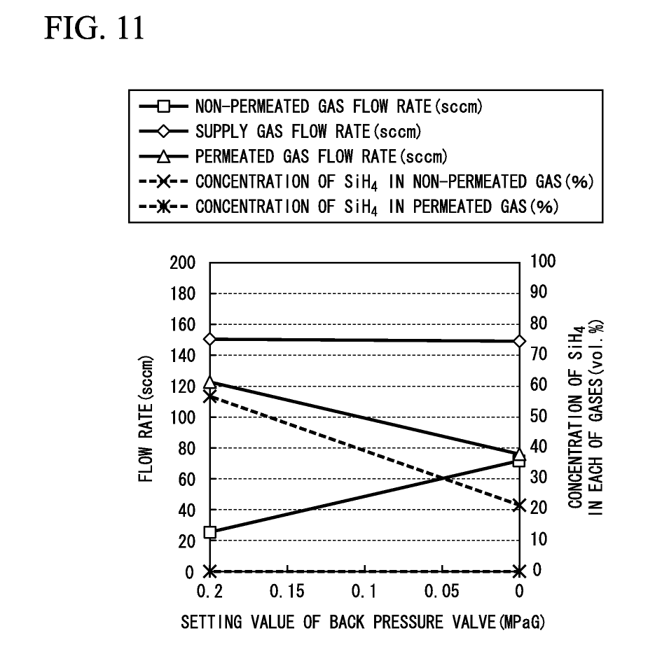

As shown in FIG. 11, at an initial stage (0.2 MPaG) where the residual gas pressure was sufficient, the concentration of monosilane (SiH₄) in the non-permeated gas could be concentrated to about 60 vol. %. On the other hand, when the residual gas pressure was 0.05 MPaG the concentration of monosilane (SiH₄) in the non-permeated gas was the concentration of 30 vol. %.

### Example B2

Recovery (batch-wise gas separation) of a residual gas was performed using the separation membrane module shown in FIG. 9.

A mixed gas was supplied to the separation membrane module in a batch manner under the following conditions, and three cycles were performed. As a result, in a case where the residual gas pressure (filling pressure) was 0.2 MPaG, the discharge pressure was 0.12 MPaG. As for the breakdown of the time required for one cycle, the first process (supply process) was about 7 minutes, the second process was about 5 minutes, and the third process (discharge process) was about 2 minutes.

Additionally, in a case where the residual gas pressure (filling pressure) was 0.05 MPaG, the discharge pressure was 0.02 MPaG. As for the breakdown of the time required for one cycle, the first process (supply process) was about 2 minutes, the second process (separation process) was about 5 minutes, and the third process (discharge process) was about 1 minute.

Additionally, gas compositions on the non-permeation side and the permeation side were measured, respectively. In addition, gas chromatography (GC-TCD) with a thermal conductivity detector was used for measurement of volume concentration. The results are shown in Table 2.

(Separation Membrane Module)
Hollow fiber-like carbon membrane tubes
Total surface area of the tubes: 1114 cm²
Retained at 25° C.

(Mixed Gas)
Mixed gas composition: 10.3 vol. % of monosilane and 89.7 vol. % of hydrogen

(Operation Conditions)
Supply gas flow rate: supply of the mixed gas at about 150 sccm
Residual gas initial pressure: 0.2 MPaG
Permeation-side pressure: −0.088 MPaG (a vacuum-pump, a vacuum generator, or the like is utilized)
Back pressure valve: set to a value equal to or slightly lower than a residual gas pressure according to the residual gas pressure.
Discharge gas flow rate: about 100 sccm or lower

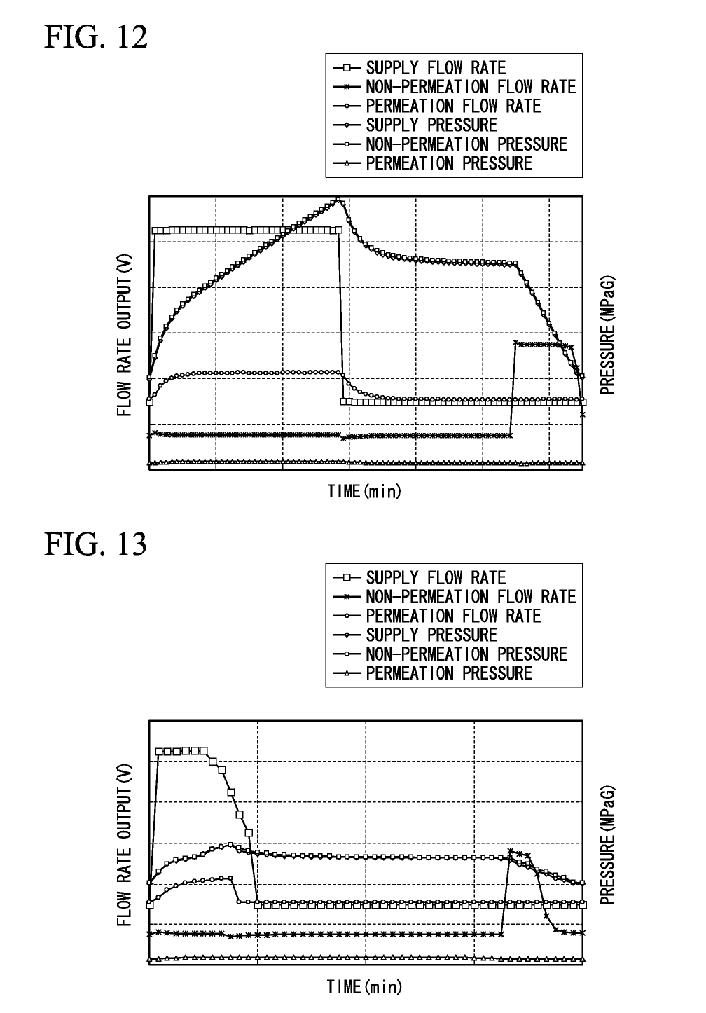

As shown in FIG. 12, at an initial stage (0.2 MPaG) where the residual gas pressure was sufficient, the concentration of monosilane (SiH₄) in the non-permeated gas could be concentrated to about 87.5 vol. %. On the other hand, as shown in FIG. 13, when the residual gas pressure was about 0 (0.05 MPaG), the concentration of monosilane (SiH₄) in the non-permeated gas was the concentration of 78.6 vol. %.

The total required time was 14 minutes when the residual gas pressure was 0.2 MPaG and was 8 minutes when the residual gas pressure was 0.05 MPaG.

The recovery amount was 91.7 cc when the residual gas pressure was 0.2 MPaG and was 22 cc when the residual gas pressure was 0.05 MPaG.

TABLE 2

| | Pressure of Residual | Concentration | | |
|---|---|---|---|---|
| | Gas in Cylinder | of Monosilane | Required Time | Total Discharge Flow |
| | (Operation Pressure for | in Non-Permeated | for One Cycle | Rate per One Cycle or |
| | Separation) (MPaG) | Gas (%) | (min) | 8 Minutes (cc) |
| Example B1 | 0.2 | 56.9 | — | 201.6 |
| | 0.05 | 30 | — | 560 |
| Example B2 | 0.2 | 87.5 | 14 | 91.7 |
| | 0.05 | 78.6 | 8 | 22 |

As shown in Table 2, Example B1 and Example B2 were compared with each other. In Example B2 in which the batch-wise gas separation was performed, the concentration of monosilane in the non-permeated gas composition could be improved to a greater extent than Comparative Example B1 in which the continuous gas separation was performed.

Additionally, even in a case where the cylinder residual pressure dropped, the concentration of monosilane in the non-permeated gas composition could be greatly enhanced in the case of the batch-wise gas separation of Example B2.

On the other hand, there are few cases where the total discharge flow rate (Total Discharge Amount×Concentration of Monosilane in Non-permeated Gas as amount of monosilane) is as in Example B2. In a case where it is intended to maintain the total discharge amount, a plurality of separation membrane modules is connected in parallel to perform separation. The total discharge amount can be maintained by continuously performing the batch-wise gas separation, though time is taken.

### INDUSTRIAL APPLICABILITY

The invention relates to a method for operating a gas separation device capable of exhibiting high gas separation performance to perform gas separation even with a small membrane area and a small number of separation membrane modules. Particularly, the invention is significantly suitable in a case where a gas component (monosilane or the like) with a large molecular diameter and a small gas component (hydrogen, helium, or the like) with a small molecular diameter are separated.

### REFERENCE SIGNS LIST

1: (1A, 1B, 1C), 220: CARBON MEMBRANE MODULE (SEPARATION MEMBRANE MODULE)
2: CARBON MEMBRANE UNIT (SEPARATION MEMBRANE UNIT)
2a: HOLLOW FIBER-LIKE CARBON MEMBRANE (GAS SEPARATION MEMBRANE)
3: GAS SUPPLY PORT
3a: OPENING AND CLOSING VALVE
4: PERMEATED GAS DISCHARGE PORT
4a: OPENING AND CLOSING VALVE
5: NON-PERMEATED GAS DISCHARGE PORT
5a: OPENING AND CLOSING VALVE
6: AIRTIGHT CONTAINER
7: RESIN WALL
8: SWEEPING GAS SUPPLY PORT
8a: OPENING AND CLOSING VALVE
9: FLOW METER
10, 20: GAS SEPARATION DEVICE (CARBON MEMBRANE MODULE UNIT)
11: FIRST SPACE
12: SECOND SPACE
13: THIRD SPACE
14a, 14b, 14c: PRESSURE GAUGE
15: BACK PRESSURE VALVE (PRESSURE REDUCING VALVE)
31, 32, 33: RECOVERY DEVICE

1. A method for operating a gas separation device that separates a gas component with a small molecular diameter from a mixed gas containing another gas component with a large molecular diameter, using two or more separation membrane modules including gas separation membranes,
wherein the two or more separation membrane modules are connected in parallel,
wherein one separation membrane module continuously repeats an operation cycle including:
a first process in which a gas supply port is opened to supply a mixed gas containing the gas component with a small molecular diameter and the gas component with a large molecular diameter into an airtight container, and fill the airtight container with pressure, in a state where a non-permeated gas discharge port provided so as to communicate with a space on a non-permeation side of the gas separation membranes, of the airtight container in which the gas separation membranes are housed, is closed, and a permeated gas discharge port provided so as to communicate with a space on a permeation side of the gas separation membranes is open;
a second process in which the gas supply port is closed to stop supply of the mixed gas and retain this state, when a predetermined time has elapsed from a start of supply of the mixed gas or when an inside of the airtight container has reached a predetermined pressure;
a third process in which the non-permeated gas discharge port is opened to recover the mixed gas containing the gas component with a large molecular diameter from the non-permeated gas discharge port, when a predetermined time has elapsed from a start of the retaining state or when the inside of the airtight container has reached a predetermined pressure; and
a fourth process in which the non-permeated gas discharge port is closed when a predetermined time has elapsed from a start of the recovery or when the inside of the airtight container has reached a predetermined pressure, and
wherein the other separation membrane module is operated in an operation cycle shifted by a predetermined interval with respect to the operation cycle of this one separation membrane module.

2. The method for operating a gas separation device according to claim 1,
wherein the gas separation membrane is any one of a silica membrane, a zeolite membrane, and a carbon membrane.

3. The method for operating a gas separation device according to claim 1,
wherein in the third process, when a drop in pressure on the non-permeation side within the airtight container has stopped, it is determined that a separation of the gas component with a small molecular diameter has been completed.

4. The method for operating a gas separation device according to claim 1,
wherein a separation membrane module is connected in series with a preceding stage of the two or more separation membrane modules which are connected in parallel, and
wherein the mixed gas is continuously supplied to the separation membrane module provided at the preceding stage, thereby performing rough separation treatment of the gas component with a small molecular diameter from the mixed gas.

5. The method for operating a gas separation device according to claim 1,
wherein the number of separation membrane modules which are connected in parallel is more than or equal to a value obtained by dividing the time required for the operation cycle by the time required for the first process, and is expressed by an integer.

6. A method for recovering a residual gas, the method comprising:
continuously supplying a mixed gas remaining in a cylinder to a separation membrane module including a gas separation membrane having a molecular sieving action;
separating the mixed gas into a gas component with a small molecular diameter and a gas component with a large molecular diameter; and then,
recovering both the gas component with a small molecular diameter and the gas component with a large molecular diameter.

7. A method for recovering a residual gas, the method comprising:
supplying a mixed gas remaining in a cylinder to a separation membrane module including a gas separation membrane having a molecular sieving action;
separating the mixed gas into a gas component with a small molecular diameter and a gas component with a large molecular diameter; and then,
recovering both the gas component with a small molecular diameter and the gas component with a large molecular diameter,
wherein the separation membrane module continuously repeats an operation cycle including:
a first process in which a gas supply port is opened to supply a mixed gas containing the gas component with a small molecular diameter and the gas component with a large molecular diameter into an airtight container, and fill the airtight container with pressure, in a state where a non-permeated gas discharge port provided so as to communicate with a space on a non-permeation side of the gas separation membranes, of the airtight container in which the gas separation membranes are housed, is closed, and a permeated gas discharge port provided so as to communicate with a space on a permeation side of the gas separation membranes is open;
a second process in which the gas supply port is closed to stop supply of the mixed gas and retain this state, when a predetermined time has elapsed from a start of supply of the mixed gas or when an inside of the airtight container has reached a predetermined pressure;
a third process in which the non-permeated gas discharge port is opened to recover the mixed gas containing the gas component with a large molecular diameter from the non-permeated gas discharge port, when a predetermined time has elapsed from a start of the retaining state or when the inside of the airtight container has reached a predetermined pressure; and
a fourth process in which the non-permeated gas discharge port is closed when a predetermined time has elapsed from a start of the recovery or when the inside of the airtight container has reached a predetermined pressure.

8. A method for recovering a residual gas, the method comprising:
supplying a mixed gas remaining in a cylinder to a separation membrane module including gas separation membranes having a molecular sieving action;
separating the mixed gas into a gas component with a small molecular diameter and a gas component with a large molecular diameter; and then,
recovering both the gas component with a small molecular diameter and the gas component with a large molecular diameter,
wherein the two or more separation membrane modules are connected in parallel,
wherein one separation membrane module continuously repeats an operation cycle including:
a first process in which a gas supply port is opened to supply a mixed gas containing the gas component with a small molecular diameter and the gas component with a large molecular diameter into an airtight container, and fill the airtight container with pressure, in a state where a non-permeated gas discharge port provided so as to communicate with a space on a non-permeation side of the gas separation membranes, of the airtight container in which the gas separation membranes are housed, is closed, and a permeated gas discharge port provided so as to communicate with a space on a permeation side of the gas separation membranes is open;
a second process in which the gas supply port is closed to stop supply of the mixed gas and retain this state, when a predetermined time has elapsed from a start of supply of the mixed gas or when an inside of the airtight container has reached a predetermined pressure;
a third process in which the non-permeated gas discharge port is opened to recover the mixed gas containing the gas component with a large molecular diameter from the non-permeated gas discharge port, when a predetermined time has elapsed from a start of the retaining state or when the inside of the airtight container has reached a predetermined pressure; and
a fourth process in which the non-permeated gas discharge port is closed when a predetermined time has elapsed from a start of the recovery or when the inside of the airtight container has reached a predetermined pressure, and
wherein the other separation membrane module is operated in an operation cycle shifted by a predetermined interval with respect to the operation cycle of this one separation membrane module.

9. The method for recovering a residual gas according to claim 6,
wherein the gas separation membrane is any one of a silica membrane, a zeolite membrane, and a carbon membrane.

10. The method for recovering a residual gas according to claim 6,
wherein the gas component with a small molecular diameter is any one of hydrogen and helium or a mixture of two or more components thereof.

11. The method for recovering a residual gas according to claim 6,
wherein the gas component with a large molecular diameter is any one among hydride gases including arsine, phosphine, hydrogen selenide, monosilane and monogermane, and rare gases including xenon and krypton, or a mixture of two or more components thereof.
